(19) United States
(12) Patent Application Publication
(10) Pub. No.: US 2018/0229950 A1
(43) Pub. Date: Aug. 16, 2018

(54) SYSTEM AND METHOD FOR HANDLING AUTOMOBILES AT A DISTRIBUTION SITE

(71) Applicant: General Electric Company, Schenectady, NY (US)

(72) Inventors: Steven Jay Tyber, Chicago, IL (US); Srinivas Bollapragada, Niskayuna, NY (US); Jian Li, Melbourne, FL (US); Ed McQuillan, Lisle, IL (US); Ajith Buddhikantha Wijeratne, Smyrna, GA (US); Joshua Kent Massey, Dacula, GA (US)

(21) Appl. No.: 15/430,734

(22) Filed: Feb. 13, 2017

(51) Int. Cl. B65G 63/00

(52) U.S. Cl. CPC B65G 63/00

(57) ABSTRACT

System includes one or more processors configured to determine loading parameters associated with section locations and zone locations. The section locations are locations of cargo sections at a product-distribution site, and the zone locations are locations of load zones at the product-distribution site. The one or more processors are also configured to assign the outbound automobiles to the load zones. The load zones are configured to have multiple outbound automobiles therein. The outbound automobiles are assigned to the load zones to reduce at least one of a total time to move the outbound automobiles from the zone locations to the section locations, a total distance to move the outbound automobiles from the zone locations to the section locations, or a total number of times in which individuals handle the outbound automobiles.

### FIELD

Embodiments of the subject matter described herein relate to handling (e.g., moving, positioning, and/or sorting) commercial products that are received at a product-distribution site.

### BACKGROUND

After commercial products are manufactured or re-furbished, the commercial products are often delivered to a product-distribution site for transporting to other regions. The product-distribution site, which may also be referred to as a distribution site, may include multiple areas in which each area is assigned a certain function or role at the product-distribution site. For example, the product-distribution site may include areas where commercial products are received and/or stored, areas in which the commercial products are positioned for loading onto vehicle systems, and areas where cargo sections of the vehicle systems are positioned for loading and/or unloading.

An example of such a distribution site is a rail terminal for transporting motor vehicles, such as automobiles. After motor vehicles are assembled at a manufacturer's factory, the motor vehicles may be transported to a nearby rail terminal. Activities at the rail terminal include assigning railcars to tracks at the distribution site, positioning incoming motor vehicles within the distribution site, unloading the motor vehicles from the railcars, and loading the motor vehicles onto the railcars. The rail terminal may include, for example, a drop zone where incoming motor vehicles are initially received, load zones where the motor vehicles are initially positioned for loading onto railcars, and pads where the railcars are positioned for loading and/or unloading. The motor vehicles are often controlled by ground teams or crews of workers in which the motor vehicles are driven from one area to another. For instance, a first team of workers may drive motor vehicles from the drop zone to the load lines. A second team of workers may drive the motor vehicles from the load lines onto the railcars. The motor vehicles are typically pulled from the front of the load lines. The second team of workers (or a different team) may also be responsible for removing motor vehicles from the railcars that were recently transported to the distribution site through a rail network. The removed motor vehicles may be moved to bay areas where the motor vehicles will be collected and transported away (e.g., by a haul-away carrier).

Daily operation of the distribution site is often closely controlled and limited by physical constraints and time limits. For instance, with respect to the above example, the railcars should be loaded prior to a cutoff time. After the cutoff time, the railcar may either stay behind or depart the site empty. As another example, the number of railcars that are received by the distribution site (or inbound railcars) and the number of railcars that depart the distribution site (or outbound railcars) are based on how quickly the commercial products may be removed from and loaded onto the railcars. Because the pads may hold only a limited number of railcars, the number of inbound and outbound railcars are related. More specifically, the number of outbound railcars may be limited to how quickly inbound railcars are unloaded and the number of inbound railcars may be limited to how quickly outbound railcars are loaded and then coupled to other railcars in a designated order.

In addition to time constraints, other challenges often arise that limit the distribution site's throughput. With respect to rail terminals, these challenges may include railcar characteristics in which the physical attributes of a railcar limit the type of products that can be transported, may reduce usable space for loading and/or unloading, or may limit how ground teams work. When these challenges arise, the distribution site must modify its operation to account for the challenges. For example, a motor vehicle may be unable to move because the motor vehicle is out of fuel or the battery is not charged. This motor vehicle may block other motor vehicles from moving and/or using physical space at the distribution site. As another example, the distribution sites typically receive advance shipment notifications (ASNs) about incoming motor vehicles. To prepare for the incoming motor vehicles, the distribution site may allocate a certain amount of physical space. These motor vehicles, however, may not arrive at the time requested by the ASN.

Current practice at some distribution sites, such as the distribution sites for motor vehicles, is predominantly manual. Present distribution sites may be ill-prepared for quickly adjusting unloading/loading plans. Failure to properly adjust unloading/loading plans may cause loaded railcars to miss their train and remain at the distribution site until the next train serving those routes is available. Similar challenges may exist at distribution sites that handle other commercial products. Accordingly, a need exists for a system and method for handling commercial products at a distribution site.

### BRIEF DESCRIPTION

In an embodiment, a system is provided. The system includes a product-distribution system (or distribution system) configured to assign outbound commercial products (e.g., automobiles) to load zones for loading onto cargo sections of one or more vehicle systems. The cargo sections are to be loaded with cargo sets of the outbound commercial products. The product-distribution system is configured to generate a work order that instructs a ground team for moving the outbound commercial products from a receiving zone to the assigned load zones.

In an embodiment, a system is provided. The system includes a product-distribution system (or distribution system) configured to assign outbound commercial products (e.g., automobiles) to load zones for loading onto cargo sections of one or more vehicle systems. The cargo sections are to be loaded with cargo sets of the outbound commercial products. The product-distribution system includes one or more processors that are configured to determine loading parameters associated with section locations and zone locations. The section locations are locations of the cargo sections at a product-distribution site (or distribution site), and the zone locations are locations of the load zones at the product-distribution site. The loading parameters are based on at least one of: (a) an amount of time to move the outbound commercial products from the zone locations to the section locations; (b) a distance to move the outbound commercial products from the zone locations to the section locations; or (c) a number of times in which individuals handle the outbound commercial products or other products in attempting to move the outbound commercial products to the section locations. The one or more processors are also configured to assign the outbound commercial products to the load zones. The load zones are configured to have multiple outbound commercial products therein. The outbound commercial products are assigned to the load zones to reduce at least one of a total time to move the outbound commercial products from the zone locations to the section locations, a total distance to move the outbound commercial products from the zone locations to the section locations, or a total number of times in which individuals handle the outbound commercial products or other products in attempting to move the outbound commercial products to the section locations. The one or more processors are also configured to generate a work order for moving the outbound commercial products from a receiving zone to the assigned load zones.

In one aspect, the one or more processors are configured to assign the outbound commercial products to the load zones to provide load sets of the outbound commercial products within the load zones. The load sets are based on the cargo sets of the outbound commercial products within the cargo sections. Optionally, the cargo sets and the load sets may be specified lines and designated lines, respectively, in which the outbound commercial products of the specified and designated lines are aligned end-to-end in series. The designated lines and the specified lines may at least partially overlapping.

In another aspect, at least some of the outbound commercial products may be assigned to the load zones as the outbound commercial products are received at the receiving zone.

In another aspect, the cargo sections may include present cargo sections in which the section locations are known to be at the product-distribution site and forecasted cargo sections in which the section locations are expected to arrive at the product-distribution site.

In another aspect, the cargo sections are sized and shaped to have a designated number of the outbound commercial products and the load zones are sized and shaped to have a designated number of the outbound commercial products. The designated number of the outbound commercial products of the load zones may not equal, for at least some cargo sections, the designated number of the outbound commercial products of the cargo sections.

In another aspect, the load zones are load lines in which the outbound commercial products are configured to be arranged end-to-end in series. The work order may include instructions for concurrently or sequentially moving all of the outbound commercial products in at least one of the load lines.

In another aspect, the outbound commercial products may be vehicles configured to be directed by individuals from the load zones to the cargo sections. For example, the vehicles may be motor vehicles that are driven by the individuals into the cargo sections.

In another aspect, the cargo sections may include railcars. The railcars may include multi-level railcars having decks with different elevations. The decks of the multi-level railcars may be configured to receive sub-sets of the cargo sets of the outbound commercial products.

In an embodiment, a method is provided that includes determining loading parameters associated with section locations and zone locations. The section locations are locations of cargo sections at a product-distribution site (or distribution site), and the zone locations are locations of load zones at the product-distribution site. The loading parameters are based on at least one of: (a) an amount of time to move outbound commercial products (e.g., automobiles) from the zone locations to the section locations; (b) a distance to move the outbound commercial products from the zone locations to the section locations; or (c) a number of times in which individuals handle the outbound commercial products or other products in attempting to move the outbound commercial products to the section locations. The method also includes assigning the outbound commercial products to the load zones. The load zones are configured to have multiple outbound commercial products therein. The outbound commercial products are assigned to the load zones to reduce at least one of a total time or a total distance to move the outbound commercial products from the zone locations to the section locations or a total number of times in which individuals handle the outbound commercial products or other products in attempting to move the outbound commercial products to the section locations. The method also includes generating a work order for moving the outbound commercial products from a receiving zone to the assigned load zones. The work order may include, for example, instructions for moving the commercial products in a designated sequence from the receiving zone to the assigned load zones.

In one aspect, the outbound commercial products may be assigned to the load zones to provide load sets of the outbound commercial products within the load zones. The load sets may be based on the cargo sets of the outbound commercial products within the cargo sections.

In another aspect, at least some of the outbound commercial products may be assigned to the load zones as the outbound commercial products are received at the receiving zone.

In another aspect, the cargo sections may include present cargo sections in which the section locations are known to be at the product-distribution site and forecasted cargo sections in which the section locations are expected to arrive at the product-distribution site.

In another aspect, the load zones may be load lines in which the outbound commercial products are configured to be arranged end-to-end in series. The work order may include instructions for concurrently or sequentially moving all of the outbound commercial products in at least one of the load lines.

In another aspect, the cargo sections may include railcars. The railcars may include multi-level railcars having decks with different elevations. The decks of the multi-level railcars may be configured to receive sub-sets of the cargo sets of the outbound commercial products.

In an embodiment, a system includes a product-distribution system (or distribution system) that is configured to generate a work order to a ground team at a product-distribution site (or distribution site) for loading outbound commercial products (e.g., automobiles) onto cargo sections. The cargo sections are configured to be transported by one or more vehicle systems. The product-distribution system includes one or more processors that are configured to determine locations of cargo sections in a cargo zone of the product-distribution site and determine a designated makeup of an outbound vehicle system. The designated makeup specifies positions of the cargo sections within the vehicle system and specifies routes of the cargo sections. The cargo sections of the vehicle system are assigned different routes. The one or more processors are also configured to assign the outbound commercial products to the cargo sections. The outbound commercial products are assigned to cargo sections to reduce a number of sorting events for at least one of marrying the cargo sections at the product-distribution site or re-sorting the cargo sections after the vehicle system has departed the product-distribution site. The one or more processors are also configured to generate the work order for loading the outbound commercial products.

In one aspect, the cargo sections may include different types of cargo sections. The different types of cargo sections have different physical attributes for transporting the outbound commercial products such that at least one type of cargo section is improper for carrying one or more of the outbound commercial products.

In another aspect, at least some of the cargo sections include inbound commercial products. The work order generated by the one or more processors may include instructions to move the inbound commercial products from the corresponding cargo sections to designated bay zones for transporting away from the product-distribution site.

In another aspect, at least some of the cargo sections may be operably joined to other cargo sections such that products may be moved through the operably joined cargo sections. The work order may include instructions to move the outbound commercial products through a first cargo section and into a second cargo section.

In another aspect, the one or more processors may be configured to monitor completion of tasks in the work order. The one or more processors may be configured to generate a new work order when a task is identified as being incapable of completion.

In some embodiments, the commercial products are motor vehicles or, more particularly, automobiles. As such, the term “commercial product” may be replaced with “motor vehicle” or replaced with “automobile” in the above Brief Description, the below Brief Description of the Drawings, and the below Detailed Description.

### BRIEF DESCRIPTION OF THE DRAWINGS

The subject matter described herein will be better understood from reading the following description of non-limiting embodiments, with reference to the attached drawings, wherein below:

FIG. 1 is a schematic diagram of a product-distribution site in accordance with one embodiment;

FIG. 2 illustrates a loading process in which the commercial products of load regions are loaded onto cargo sections in accordance with an embodiment;

FIG. 3 illustrates the loading process after the point in time in FIG. 2 in which the cargo sections are partially filled and the load zones are partially emptied;

FIG. 4 illustrates a transportation network that includes the product-distribution site of FIG. 1;

FIG. 5 illustrates how vehicle systems with multiple discrete strings can be separated and combined to form other vehicle systems;

FIG. 6 illustrates different strings of vehicles of a rail network on different tracks;

FIG. 7 illustrates how the strings of the vehicles of a rail network may be combined to form a vehicle system in accordance with an embodiment;

FIG. 8 illustrates a vehicle system that has been constructed by combining a plurality of strings in accordance with an embodiment;

FIG. 9 illustrates a product-distribution system in accordance with an embodiment;

FIG. 10 is a flow chart illustrating a method in accordance with an embodiment that may be executed or performed by the product-distribution system of FIG. 9; and

FIG. 11 is a flow chart illustrating a method in accordance with an embodiment that may be executed or performed by the product-distribution system of FIG. 9.

### DETAILED DESCRIPTION

Embodiments set forth herein include systems and methods for handling (e.g., moving, positioning, and/or sorting) commercial products at a product-distribution site, which may also be referred to as a distribution site. Embodiments may be configured to, for example, increase throughput of the product-distribution site and/or improve efficiency of the product-distribution site. The commercial products may be any products capable of being transported through one or more transportation networks. The commercial products may be ready for immediate use (e.g., by a consumer), or the commercial products may be intermediary components that are used to assemble another commercial product. In particular embodiments, the commercial products include motor vehicles. As used herein, a “motor vehicle” is a vehicle having a motor that is carried with the vehicle. In more particular embodiments, the motor vehicles are automobiles. As used herein, an “automobile” is a road vehicle having one or more wheels in which the road vehicle is powered by an engine or motor (e.g., internal combustion engine or electric motor) and is designed to carry at least one person in addition to the engine or motor. The term includes automobiles that are capable of operating autonomously (e.g., cars with accident avoidance systems, cars that are capable of being driverless, self-driving cars, robotic cars, etc.).

The transportation networks may include road networks, rail networks, airline networks, and/or shipping networks (e.g., shipping on boats). Particular embodiments may reduce an amount of time and/or distance in which the commercial products are moved within the product-distribution site and/or reduce an amount of time for sorting cargo sections that hold the commercial products.

Embodiments may include plural models (or modules) that monitor designated areas of a distribution site and issue instructions for how the commercial products may be moved within the product-distribution site. The models may monitor the execution of work and dynamically deploy new instructions in response changing conditions. For example, the instructions may be issued to ground teams that that move and handle the commercial products within the product-distribution site. As used herein, a “crew” or “team” may include individuals (e.g., humans) and/or robots.

One or more embodiments may include a tactical planning module that allocates physical space at the product-distribution site for different activities. One or more embodiments may include a product management module that assigns inbound commercial products to different locations within the physical space as the commercial products arrive. One or more embodiments may include a load planning module that manages the loading and/or unloading of vehicle systems. For example, the load planning module may generate instructions for unloading commercial products from the vehicle system and/or generate instructions for loading commercial products onto the vehicle system. One or more embodiments may include a work order system that deploys instructions generated by other models and tracks the execution of work orders and/or related tasks.

A more particular description of the inventive subject matter briefly described above will be rendered by reference to specific embodiments thereof that are illustrated in the appended drawings. The inventive subject matter will be described and explained with the understanding that these drawings depict only typical embodiments of the inventive subject matter and are not therefore to be considered to be limiting of its scope. Wherever possible, the same reference numerals used throughout the drawings refer to the same or like parts. To the extent that the figures illustrate diagrams of the functional blocks of various embodiments, the functional blocks are not necessarily indicative of the division between hardware and/or circuitry. Thus, for example, components represented by multiple functional blocks (for example, processors, controllers, or memories) may be implemented in a single piece of hardware (for example, a general purpose signal processor, microcontroller, random access memory, hard disk, or the like). Similarly, any programs and devices may be standalone programs and devices, may be incorporated as subroutines in an operating system, may be functions in an installed software package, or the like. The various embodiments are not limited to the arrangements and instrumentality shown in the drawings.

At least one technical effect of one or more embodiments includes increasing throughput of a product-distribution site such that a greater number of commercial products may be received and transported from the product-distribution site within a designated period of time. Another technical effect may include reducing a number of adverse events (e.g., damage to products or work delays or stoppages) that occur at the product-distribution site. Another technical effect may include reducing a number of sorting events that occur within a transportation network, thereby increasing efficiency and/or throughput.

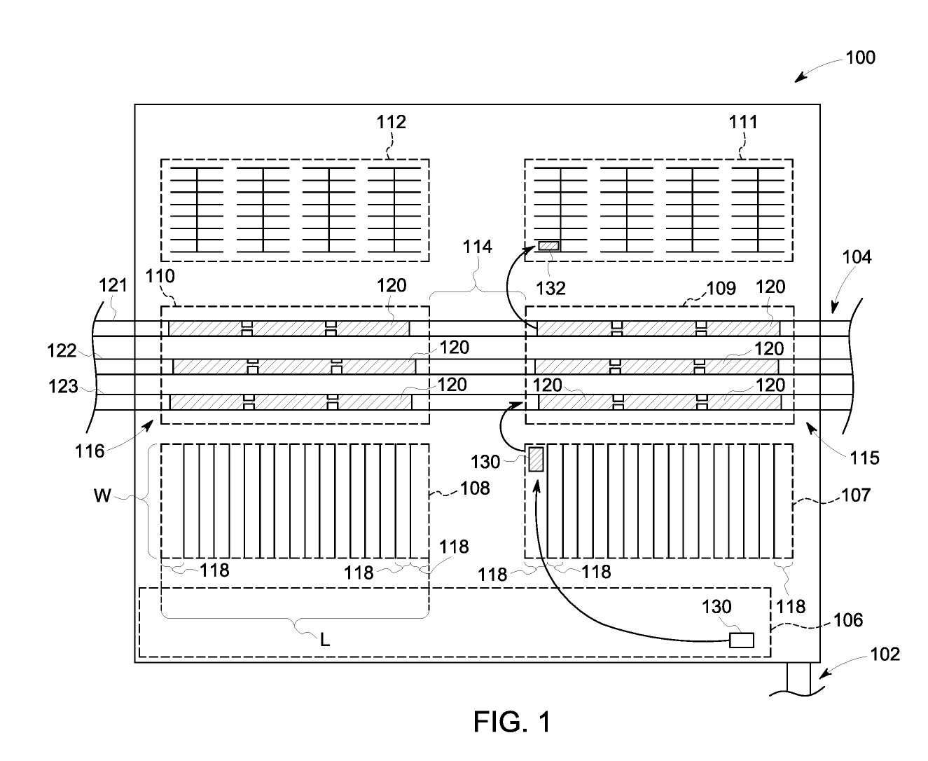

FIG. 1 is a schematic diagram of a product-distribution site 100 in accordance with an embodiment. The product-distribution site 100 is configured to receive commercial products 130 and move, position, and/or sort the commercial products 130 for transporting with one or more vehicle systems. A vehicle system includes at least one propulsion-generating vehicle and multiple cargo sections 120 that are driven by the propulsion-generating vehicle. Optionally, the cargo sections 120 may be non-propulsion-generating vehicles (e.g., railcars). The vehicle systems may include various vehicle systems that are capable of carrying cargo (or freight). Non-limiting examples of such vehicle systems include trains, haul-away carriers, cargo ships, cargo aircraft, and off-highway vehicles (e.g., mining vehicles or other vehicles that are not designed for or permitted to travel on public roadways).

In some embodiments, the product-distribution site 100 interconnects multiple types of transportation networks such that commercial products 130 received at the product-distribution site 100 through one transportation network may depart the product-distribution site 100 through a different transportation network. For example, a single product-distribution site 100 may interconnect a road network, a rail network, and an ocean or inland port. The product-distribution site 100 is configured to load and unload commercial products 130 from the cargo sections 120 and move the commercial products 130 with the same mode of transportation or other modes of transportation. The cargo sections 120 are configured to hold the commercial products 130 as the commercial products 130 transported through at least one of the transportation networks. The cargo sections 120 may include, for example, railcars or intermodal containers. The cargo sections 120 typically hold multiple commercial products 130, which may be collectively referred to as a set for each cargo section 120. The cargo sections 120 may separate the commercial products 130 from other commercial products 130. The cargo sections 120 may be configured to protect the commercial products 130 during transport.

In particular embodiments, the product-distribution site 100 is a rail terminal that is configured to receive and transfer the commercial products 130 through a rail network and, optionally, a road network. For example, the product-distribution site 100 may receive the commercial products 130 from a factory (not shown) and transport the commercial products 130 with one or more trains and/or one or more haul-away carriers. The trains may include one or more locomotives and one or more railcars. The product-distribution site 100 may be configured to unload the commercial products 130 from the trains and load the commercial products 130 onto the carriers. The product-distribution site 100 may also be configured to load the commercial products 130 onto the trains and unload the commercial products 130 from the carriers.

To this end, the product-distribution site 100 includes multiple activity regions 106-112 where the commercial products 130 and/or the vehicle systems are positioned during operation of the product-distribution site 100. The activity regions 106-112 are physical spaces that may be at least temporarily occupied by the commercial products 130 and/or the vehicle systems. The activity regions 106-112 may be physical spaces where the commercial products 130 are stored or through which the commercial products 130 are moved. For example, the product-distribution site 100 includes a receiving zone (or drop zone) 106 that is configured to receive the commercial products 130 through a transportation network 102, which may be referred to as the first transportation network 102 in some embodiments. The transportation network 102 is a road network in FIG. 1. More specifically, the road network 102 includes interconnected roads (e.g., highways or other roads). As an example, a haul-away carrier may arrive through the first transportation network 102 and unload multiple commercial products 130 (e.g., motor vehicles) at the receiving zone 106. Embodiments may then identify the commercial products 130 at the receiving zone 106 and assign the commercial products 130 to other regions of the product-distribution site 100.

The product-distribution site 100 also includes a load region 107 and a load region 108, which may be referred to as first and second load regions 107, 108. The load regions 107, 108 are spaced apart from each other. For example, workers and/or commercial products 130 may be moved between the load regions 107, 108. Although only two load regions are shown in FIG. 1, it should be understood that the product-distribution site 100 may include more than two load regions (e.g., three, four, five, six, seven, eight, nine, ten, or more). In some embodiments, the load regions may occupy a substantially large area. For example, the load regions may have a collective length that is 0.5 kilometers (km) or more or a collective length that is 1.0 km or more. A width of the large area may be, for example, large enough to have two or more load regions.

In the illustrated embodiment, the load regions 107, 108 include plural load zones 118 that are configured to hold multiple commercial products 130. The load zones 118 are sub-areas of the load regions 107, 108. The load zones 118 may be equally sized or have different sizes. In some embodiments, the load zones 118 are sized and shaped to receive a designated load set or group of the commercial products 130. In particular embodiments, the load zones 118 are load lines (or load lanes) in which each of the load lines is sized and shaped to receive a line of the commercial products 130. For example, a load line may receive at least five motor vehicle that are positioned end-to-end and facing in the same direction. As shown, the load zones 118 are arranged side-by-side such that each load zone 118 extends across an entire width W of the load region.

The load regions 107, 108 can be physical spaces of the product-distribution site 100 where the commercial products 130 are stored until the commercial products 130 are loaded onto cargo sections 120. The load regions 107, 108 may be aligned in a linear manner (e.g., five separate load regions forming a one-dimensional array). The load regions may also be positioned in a two-dimensional array (e.g., sixteen separate load regions forming a 2×8 array, twelve separate load regions forming a 3×4 array, or twelve load regions forming a 2×6 array). Optionally, the commercial products 130 are temporarily stored in the load regions 107, 108 such that the commercial products 130 are positioned at the load regions 107, 108 for, on average, at most two days. In certain cases, the commercial products 130 may be temporarily stored such that the commercial products 130 are positioned at the load regions 107, 108 for, on average, at most one day, at most sixteen (16) hours, or at most twelve (12) hours. The load regions 107, 108 may be configured to hold hundreds or thousands of commercial products 130 throughout a day.

The product-distribution site 100 also includes separate cargo zones 109, 110 where the cargo sections 120 are positioned. Although the product-distribution site 100 has only two cargo zones 109, 110 in FIG. 1, it should be understood that embodiments may have only one cargo zone or more than two cargo zones. For example, in other embodiments, the product-distribution site 100 may include three, four, five, six, seven, eight, or more cargo zones. The cargo zones may be aligned in a linear manner (e.g., five separate cargo zones positioned end-to-end to form a one-dimensional array). The cargo zones may also be positioned in a two-dimensional array (e.g., eight separate cargo zones forming a 2×4 array).

The cargo sections 120 are configured to hold the commercial products 130 during transport. The cargo sections 120 have designated locations within the cargo zones 109, 110. To distinguish these locations from the locations of other objects within the product-distribution site 100, the locations of the cargo sections may be referred to as “section locations.” In some embodiments, the cargo sections 120 have known locations with respect to one another within the cargo zones 109, 110. For example, a first cargo section and a second cargo section may be positioned adjacent to each other such that the first and second cargo sections are aligned end-to-end or side-to-side. In either instance, the first and second cargo sections may be stacked relative to one another or coupled to one another through a device (e.g., coupler). As one example, adjacent railcars may be joined to one another using couplers.

The cargo zones 109, 110 may be positioned to facilitate loading and unloading the commercial products 130 with respect to the cargo sections 120. By way of example, the cargo zones 109, 110 are separated by an access area 114. The access area 114 allows the commercial products 130 to be transferred therethrough for loading onto the cargo sections 120 in one or both of the cargo zones 109, 110. For example, the commercial products 130 may be moved through the access area 114 and up a ramp (not shown) into the cargo sections 120. The cargo zone 109 may be positioned between the access area 114 and another access area 115, and the cargo zone 110 may be positioned between the access area 114 and another access area 116. Similar to the access area 114, the access areas 115, 116 allow the commercial products 130 to be moved therethrough for loading onto the cargo sections 120. The access areas 114-116 may be sized to, for example, permit ramps (not shown) to be coupled to the cargo sections 120 and/or permit equipment or machinery to move therethrough.

Optionally, tracks 121-123 extend through the cargo zone 109 and extend through the cargo zone 110. The tracks 121-123 may extend through other cargo zones if such cargo zones exist. The tracks 121-123 also extend through the access areas 114-116. The tracks 121-123 are operably connected to a rail network so that the cargo sections 120 may depart the product-distribution site 100 on tracks and may be received by the product-distribution site 100 on tracks. In the illustrated embodiment, the tracks 121-123 are configured to guide railcars. The tracks 121-123 include two rails that extend parallel to one another, such as those used to guide trains. The tracks 121-123 may join each other downstream and/or upstream from the segments shown in FIG. 1.

In alternative embodiments, the tracks 121-123 may be other types of tracks that guide cargo sections therealong. For example, the tracks 121-123 may be conveyor belts that extend through the cargo zones 109, 110. Yet in other embodiments, the product-distribution 100 does not include tracks. For example, the cargo zones 109, 110 may include palettes that are configured to hold one or more cargo sections. The palettes may be movable. For example, a crane may be configured to hoist and move the palettes with cargo sections loaded thereon. The palettes may be configured to be positioned side-to-side or end-to-end in the cargo zones 109, 110. In some embodiments, the cargo zones 109, 110 includes intermodal containers therein that are stacked with respect to one another. A crane may be configured to hoist and move the intermodal containers onto the vehicle systems, such as waterway ships.

As described herein, the cargo sections 120 may be positioned relative to one another within the cargo zones 109, 110 to achieve a designated arrangement of the cargo sections 120. In particular embodiments, the cargo sections 120 may be positioned relative to one another within the cargo zones 109, 110 to achieve the designated arrangement when the cargo sections 120 are carried by the vehicle system(s). For example, the cargo sections 120 may be railcars that are configured to be coupled end-to-end in series through couplers and moved by a locomotive along a rail network. The railcars may have a designated arrangement that reduces an amount of coupling and de-coupling (or switching) of the railcars at a later time. In the illustrated embodiment, the cargo sections 120 are railcars.

The product-distribution site 100 also includes bay areas (or zones) 111, 112. The bay areas 111, 112 may be similar to the load regions 107, 108. In some cases, the bay areas 111, 112 may be identical to the load regions 107, 108, except that the bay areas 111, 112 are configured to receive commercial products 130 that are unloaded from the cargo sections 120. It is contemplated that the areas that define the bay areas 111, 112 and the areas that define the load zones 107, 108 may be switched in some embodiments. For example, an area of the product-distribution site 100 may function as a bay area during a first time period and function as a load zone during a second time period. In some embodiments, one or more areas may simultaneously function as a bay area and load zone.

Although the following may describe commercial products 130 as being motor vehicles 130 and the cargo sections 120 as being railcars 120, it should be understood that one or more embodiments may be suitable for other types of commercial products 130 or cargo sections 120. For example, the commercial products 130 may be other large machines or appliances. In particular embodiments, the product-distribution site 100 is configured to receive and distribute heavy commercial products 130, such as those that exceed 200 kilograms, those that exceed 500 kilograms, or those that exceed 1000 kilograms. In some embodiments, the commercial products 130 may require individual handling for loading onto the cargo sections 120 and/or unloading from the cargo sections 120. For example, it may be necessary for at least one person to physically move with the commercial product 130.

The following describes a product-distribution cycle (or distribution cycle) of a motor vehicle 130 that is received at the product-distribution site 100. The product-distribution cycle may be generally applied to other commercial products 130 as described above. As such, the term “motor vehicle” or “automobile” in the present application may be generally replaced with the term “commercial product” and vice versa. Similarly, the term “railcar” in the present application may be generally replaced with the term “cargo section” and vice versa. In particular embodiments, the motor vehicle 130 must be handled (e.g., driven) by an individual (e.g., person or robot) when the motor vehicle 130 is loaded or unloaded. It is contemplated, however, that the motor vehicle 130 may be automatically controlled during loading and/or unloading. For example, the motor vehicles 130 may be controlled through autopilot mode and/or remote control.

The motor vehicle 130 may be received through the first transportation network 102. The motor vehicle 130 may also be referred to as an “inbound motor vehicle.” For example, motor vehicles 130 may be driven individually to the receiving zone 106 or driven as part of a group or set of motor vehicles 130 (e.g., by a haul-away carrier) and then unloaded into the receiving zone 106. In some embodiments, a notice is issued to the product-distribution site 100 prior to the motor vehicles 130 being delivered. The notice may inform the product-distribution site 100 as to when the motor vehicle(s) can be expected to arrive. For example, an advance shipment notification (ASN) may be communicated to the product-distribution site 100. The ASN may include an estimated time of arrival (ETA) to the product-distribution site 100. Optionally, the ASN may include other information regarding the motor vehicle 130, such as a destination or instructions for storage or shipping. Although the above describes only a single motor vehicle 130 being moved, it should be understood that a plurality of motor vehicles 130 may be moved concurrently or may be moved one after the other. For example, the product-distribution site 100 may have hundreds or thousands of motor vehicles 130 move through the product-distribution site 100 in a single day.

In some embodiments, the motor vehicle 130 is identified when the motor vehicle is delivered to the receiving zone 106. For example, the motor vehicle may have an identification number (e.g., vehicle identification number (VIN)) associated with the motor vehicle. The identification number may be identified to determine information about the motor vehicle 130. For instance, the identification number may identify the manufacturer and operating characteristics about the motor vehicle 130. As a particular example, the motor vehicles 130 may be scanned by an individual to determine the identification number. It is contemplated, however, that the motor vehicles 130 may be identified through other manners. For example, a camera may image at least a portion of the motor vehicle 130 and identify the motor vehicle 130 through analysis of the image.

After being received at the receiving zone 106, the motor vehicle 130 may be moved (e.g., by an individual) to one of the load regions 107, 108 and, in particular, to a designated load zone 118. Embodiments may assign the motor vehicle 130 to the load zone 118. After being assigned to a load zone 107, 108, the motor vehicle 130 may be referred to as an “outbound motor vehicle.” The motor vehicle 130 may be moved immediately after scanning and identification or soon after scanning and identification (e.g., within 15 minutes). In some cases, the motor vehicle 130 may be moved to another portion of the receiving zone 106 and stored at the other portion of the receiving zone 106.

As described herein, the load zones 118 at which the motor vehicles 130 are positioned may be selected to reduce at least one of an amount of time to move the motor vehicle 130 from the load zone 118 to the railcar 120; a distance to move the motor vehicle 130 from the load zone 118 to the railcar 120; a number of times in which individuals handle the motor vehicle 130 (or other motor vehicles 130) in attempting to move the motor vehicle 130 toward the railcar 120; or to reduce blockages in the load zones 118 caused by stationary motor vehicles 130 or other objects. As such, embodiments may increase a throughput and/or an operating efficiency of the product-distribution site. Alternately or in addition to the above, the railcars selected for receiving the motor vehicles 130 may be configured to reduce a number of sorting events for at least one of marrying the railcars 120 at the product-distribution site 100 or re-sorting the railcars 120 after the vehicle system has departed the product-distribution site 100. As such, embodiments may increase a throughput and/or an operating efficiency of a transportation network that includes the product-distribution site 100.

As shown, a motor vehicle 132 may also arrive at the product-distribution site 100 in one of the railcars 120. The motor vehicle 132 may also be referred to as an “inbound motor vehicle.” For example, a train may arrive at the product-distribution site 100. The railcars 120 of the train may be separated from one another and positioned in at least one of the cargo zones 109, 110. The motor vehicles 132 may be unloaded from the railcars 120 and positioned at one or more of the bay areas 111, 112. The bay areas 111, 112 may be selected to reduce at least one of an amount of time to move the motor vehicle 132 from the railcar 120 to the bay area; a distance to move the motor vehicle 132 from the railcar 120 to the bay area; a number of times in which individuals handle the motor vehicle 132 (or other motor vehicles 132) in moving the motor vehicle 132 toward the bay area; or an amount of time to load the motor vehicle 132 onto another vehicle system, such as a haul-away carrier.

In some embodiments, the individuals and/or robots that move the motor vehicles 132 from the railcars 120 to the bay areas 111, 112 may include at least some of the individuals and/or robots that move the motor vehicles 130 from the load zones 118 to the railcars 120. Likewise, the locations of the railcars 120 within the cargo zones 109, 110 may be selected to reduce at least one of an amount of time to move the motor vehicle 132 from the railcar 120 to the bay area; a distance to move the motor vehicle 132 from the railcar 120 to the bay area; or a number of times in which individuals handle the motor vehicle 132 in moving the motor vehicle 132 toward the bay area.

The above description relates to the movement of a single motor vehicle to or from a single railcar 120. In many cases, several motor vehicles will be moved, such as by a ground team of individuals. Several motor vehicles may be moved simultaneously (e.g., at the same time), concurrently (e.g., at overlapping times), and/or sequentially (e.g., moved one after the other). For instance, the motor vehicles 130 in one or more load zones 118 may be moved concurrently to a single railcar 120 or group of railcars 120 that are operably joined. As one particular example, six drivers of a ground team may drive six respective motor vehicles 130 to a plurality of railcars 120 that are operably joined. In this example, the operably joined railcars 120 may be the railcars 120 in the cargo zone 109 along track 121.

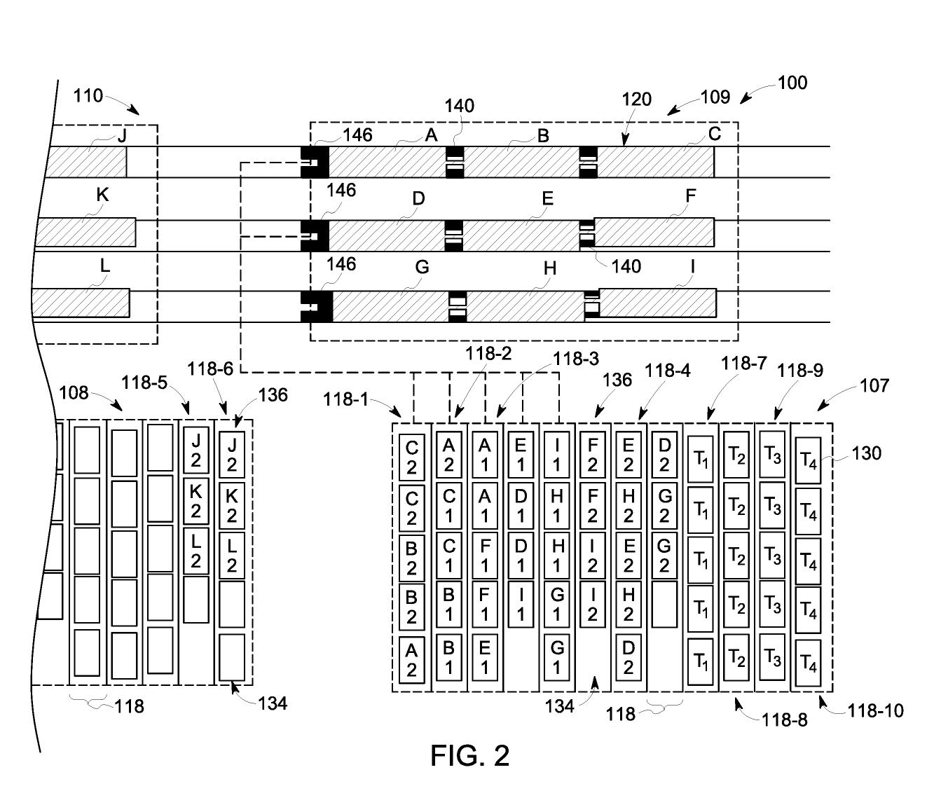

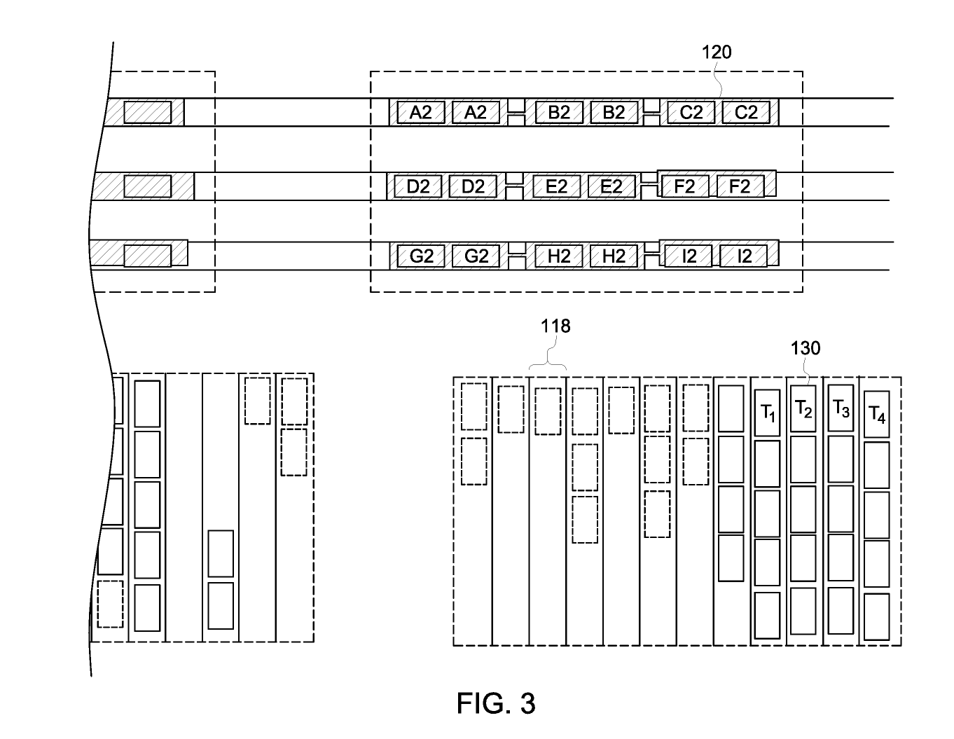

FIGS. 2 and 3 illustrate the load regions 107, 108 and the cargo zones 109, 110 of the product-distribution site 100 at different times of operation. During operation of the product-distribution site 100, the motor vehicles 130 may be added to the load regions 107, 108 (e.g., parked within the load zones 118) and removed from the load regions 107, 108 (e.g., driven away from the load zones 118) at different rates. The number of motor vehicles 130 shown in FIGS. 2 and 3 is for illustrative purposes only, and it should be understood that the load regions 107, 108 may contain a constantly changing number of motor vehicles 130 during operation. For example, a first ground team may be frequently or constantly moving the motor vehicles 130 from the receiving zone 106 (FIG. 1) to an assigned load zone 118. A second ground team may be frequently or constantly moving the motor vehicles 130 in the load zones 118 to the assigned railcars 120. Optionally, additional ground teams may be used in the product-distribution site.

The motor vehicles 130 may be assigned to the load zones 118 of the load regions 107, 108 as the motor vehicles 130 are received at the receiving zone 106 (FIG. 1). The load zones 118 are filled with designated load sets of the motor vehicles 130. The railcars 130 are filled with designated cargo sets of the motor vehicles 130. As used herein, a “cargo set” or a “load set” includes a group of commercial products (e.g., two, three, four, five, six, seven, eight, or more commercial products). In some embodiments, the identities of the commercial products in a set are known and the order of the commercial products in the load zone or cargo section is known. In other embodiments, although the identities of the commercial products in a set may be known, the order of the commercial products in the load zone or cargo section may not be known.

The load sets and the cargo sets are based on the makeups of the vehicle systems that are scheduled to depart the product-distribution site 100. More specifically, the vehicle systems that depart the product-distribution site 100 have a designated arrangement of the railcars 120 and the railcars 120 have the cargo sets of the motor vehicles 130. The designated makeup may specify the positions of the railcars 120 with respect to one another in the vehicle system. The designated makeup may also specify the types of railcars 120. For instance, different types of railcars 120 have different physical attributes for transporting the motor vehicles 130 such that at least one type of railcar 120 is improper for carrying one or more types of motor vehicles 130. Optionally, the designated makeup of the vehicle system may also specify the routes of the railcars 120.

The designated makeup of the railcars 120 may be based on a blocking plan. The blocking plan may assign routes to certain segments of the vehicle system. Each segment of the vehicle system may include one or more railcars 120. When determining the makeup of the vehicle system, each railcar 120 may be assigned one of these routes. Each route ends at a respective destination where the railcars 120 having the route with the respective destination will be unloaded. As the vehicle systems travel through the transportation network 104, the railcars 120 may be separated and re-combined with other railcars 120 prior to arriving at the final destination. Thus, the blocking plan may be configured to reduce the number of sorting events by having railcars with the same or similar routes grouped together. The designated makeup of the railcars 120 may be configured to also reduce the number of sorting events. In particular, embodiments may assign motor vehicles 130 to railcars 120 to reduce a number of sorting events for at least one of marrying the railcars 120 at the product-distribution site 100 or re-sorting the railcars 120 after the vehicle system has departed the product-distribution site 100.

Optionally, the designated makeup of the vehicle system may also specify the number and type of motor vehicles within the railcars 120. In such embodiments, the designated makeup of the railcars 120 is based on a load plan. A load plan may provide instructions for loading the motor vehicles 130 onto the railcars 120. The load plan may be directly or indirectly based on the blocking plan The load plan may also be based on the inventory (current inventory and/or expected inventory) of outbound motor vehicles 130 that are at the product-distribution site 100.

In particular embodiments, the positions and types of the railcars 120 in the cargo zones 109, 110 may be analyzed to determine how the railcars 120 should be filled with the motor vehicles 130 in order to create the designated vehicle systems. The load sets may or may not have a substantially predetermined order based on how the railcars 120 are filled. Embodiments may fill the load zones 118 with designated load sets of the motor vehicles 130 such that the railcars 120 have the specified motor vehicles 130 therein after loading. To this end, the designated load sets of the motor vehicles 130 in the load zones 118 may at least partially overlap with the specified cargo sets that fill the railcars 120. For example, the load zones 118 may form load lines in the illustrated embodiment such that the load sets include a column of the motor vehicles 130. In other embodiments, the load zones 118 may have other shapes such that more than one column may exists. Nonetheless, the load sets in the alternative load zones 118 may have a substantially predetermined order.

In some embodiments, one or more of the load zones 118 may be a “fill load zone” that is filled with only one type of motor vehicle. For example, some embodiments may have ten fill load zones in which each of these load zones is filled with a respective type of motor vehicles. During operation at the production-distribution site 100, if an adverse event occurs in which one of these types of motor vehicles is unavailable through one of the other load zones having the aforementioned load sets, this type of motor vehicle may be pulled from the fill load zone. As a specific example, if a load zone becomes blocked and the ground team is unable to move two types of cars from the load set, these types of cars may be pulled from the respective fill load zones to complete the cargo set. Examples of such fill load zones are shown in FIG. 2 for load zones 118-7 to 118-10. Each of the 118-7 to 1118-10 has its own type of motor vehicle 130. Thus, embodiments may include load zones with specified load sets having different types of motor vehicles 130 and fill load zones having only one type of motor vehicles.

As set forth herein, embodiments may generate at least one of a load plan, a blocking plan, and a designated makeup of the railcars that is configured to reduce the number of sorting events. The load plan, the blocking plan, or the designated makeup may be achieved through work orders that may be generated by some embodiments. The work orders may specify tasks that are to be achieved at the product-distribution site 100. For example, the tasks specified include moving a motor vehicle 130 from one location to another location. The work order may specify a sequence of moving the motor vehicles. For example, the work order may specify to move motor vehicle A prior to moving motor vehicle B and/or motor vehicle C. The work order may also specify a time or time period to move the motor vehicles 130. For example, the work order may specify to move motor vehicle A by a designated time or within a designated time period. The work order may specify to move a set of motor vehicles (e.g., load set) by a designated time or within a designated time period. As another example, the work order may specify to have designated railcars 120 loaded prior to a designated time (e.g., cutoff time).

In the illustrated embodiment, the load zones 118 have an entrance 134 and an exit 136. For embodiments in which the load zones 118 are load lines or load lanes, the entrance 134 and the exit 136 may be positioned at opposite ends of the load zones 118. The entrances 134 are configured to receive the motor vehicles 130 from the receiving zone 106 (FIG. 1). The exits 136 are configured to permit the motor vehicles 130 to move therethrough when the motor vehicles 130 are loaded onto the railcars 120. The line of motor vehicles 130 may form a first-in first-out (FIFO) queue in the load zones 118. As shown, the motor vehicles 130 may have stationary positions (e.g., may be parked) within the load zones 118.

In alternative embodiments, the load zones 118 may include only a single access point into the load zones 118. For example, the motor vehicles 130 may be moved through the entrance 134 and back through the entrance 134 when the motor vehicles 130 are moved to the railcars 120. The line of motor vehicles 130 may form a last-in first-out (LIFO) queue.

The motor vehicles 130 of one load zone 118 may be loaded into at least one railcar 120. For example, the motor vehicles 130 of a load set of one load zone 118 may be driven onto a ramp and loaded onto the operably joined railcars 120. FIGS. 2 and 3 show operably joined railcars 120 that are designated as A, B, and C. When the railcars A, B, and C are operably joined, bridges 140 extend between adjacent railcars to permit the motor vehicles 130 to be driven from one railcar 120 to the adjacent railcar 120. For example, the motor vehicles 130 may be driven onto a ramp 146 and initially loaded onto the railcar A. The motor vehicles 130 may drive entirely through the railcar A and into the railcar B and, optionally, into the railcar C. The operably joined railcars A, B, and C may be referred to as a string of railcars, because the railcars are coupled to one another in series.

The railcars A, B, and C are multi-level railcars. It should be understood that different levels of a railcar may be operably joined to the same levels of the adjacent railcar. For example, the first level of the railcar A may be operably joined through bridges 140 to the first level of the railcar B, which may be operably joined through bridges 140 to the first level of the railcar C. Similarly, the second level of the railcar A may be operably joined through bridges 140 to the second level of the railcar B, which may be operably joined through bridges 140 to the second level of the railcar C.

For such embodiments in which the railcars 120 have multiple levels and those multiple levels may be operably joined, the cargo set of a railcar may include multiple cargo sub-sets. For example, the motor vehicles 130 on the first level may be a first cargo sub-set of the railcar, and the motor vehicles on the second level may be a second cargo sub-set of the rail car. The cargo set of the railcar includes the first cargo sub-set and the second cargo sub-set. In such embodiments, when the load zones 118 are filled with the load sets, the load sets may include a series of cargo sub-sets of the same number. For example, a load zone 118 may include two or more first cargo sub-sets.

It is noted that a single load zone 118 may not contain an equal number of motor vehicles 130 that will be loaded into a single railcar 120 or a string of railcars 120. In FIGS. 2 and 3, the load zones 118 may contain at most five (5) of the motor vehicles 130 and the string of railcars A, B, and C are capable of receiving six (6) of the motor vehicles 130 per level. If the railcars 120 have two levels, then the string of railcars A, B, and C are capable of receiving twelve (12) of the motor vehicles 130. Assuming the load zones 118 are full, the string of railcars A, B, and C may receive the motor vehicles 130 from two load zones 118 and two of the motor vehicles 130 from another load zone 118. Accordingly, the arrangement of the motor vehicles in a load set may be a function of at least one of: (a) the number of motor vehicles that may be positioned in the load zone (or capacity of the load zone); (b) the number of motor vehicles that may be positioned in a single railcar (or capacity of the railcar); (c) the number of motor vehicles that may be positioned in a string of operably joined railcars; or (d) the number of levels in the railcars.

As described above, the load regions 107, 108 may be in constant flux with motor vehicles 130 being frequently removed from the load regions 107, 108 and the motor vehicles 130 being frequently added to the load regions 107, 108. To illustrate activity during operation of the product-distribution site 100, FIGS. 2 and 3 identify the motor vehicles 130 by a letter (e.g., A) and a number (e.g., 1). The letter identifies the railcar 120, and the number identifies the level at which the motor vehicle 130 will be positioned within the railcar 120. More specifically, the railcar 120 may have one level, two levels, or three levels. In the following example, the railcar 120 have two levels (1 and 2).

As the motor vehicles 130 are received at the receiving zone 106 (FIG. 1), embodiments may identify the motor vehicle 130 and assign a load zone 118 for the identified motor vehicle. The motor vehicles may be assigned to load zones 118 so that the motor vehicles 130 are grouped together in the load set. For example, the motor vehicles 130 may be assigned to load zones 118 such that a ground team may remove at least two of the motor vehicles in the same load zone 118 and/or at least two of the motor vehicles from adjacent load zones. The motor vehicles 130 may be adjacent to one another. As used herein, adjacent motor vehicles 130 are motor vehicles positioned end-to-end in a single load zone, side-by-side in adjacent load zones, are otherwise positioned near each other without another motor vehicle therebetween. In particular embodiments, the load sets may be configured to reduce (a) an amount of time (e.g., estimated or predicted time) to move the motor vehicle 130 from the load zone 118 to the cargo section 120; (b) a distance (e.g., estimated or predicted distance) to move the motor vehicle 130 from the load zone 118 to the cargo section 120; (c) a number of times (e.g., estimated or predicted number of times) in which an individual handles the motor vehicle 130 or another motor vehicle 130 in attempting to move the motor vehicle 130 toward the assigned cargo section 120; or (d) blockages in the load zones 118 caused by stationary motor vehicles 130. In particular embodiments, each and every motor vehicle 130 in a load zone 118 may be moved concurrently to one or more cargo sections 120. For example, a ground team may move each and every motor vehicle 130 from two load zones 118 and one or more motor vehicles 130 from an adjacent load zone 118 in a single moving session.

Motor vehicles may be moved during a moving session. As used herein, a “moving session” is a time period that includes a motor vehicle being moved from the load zone toward the cargo zone and then being loaded into the cargo section. Moving sessions may include a team of workers who concurrently drive a plurality of the motor vehicles. A team of workers may be moved around the product-distribution site in one or more team carriers (e.g., one or more moving vans or other vehicles). For some moving sessions, a motor vehicle is continuously driven by the same person from the load zone to the railcar. In other words, the same person may drive the motor vehicle from the load zone, onto a ramp, into a railcar, and to a final position within the assigned railcar. For other moving sessions, however, multiple individuals may drive a single motor vehicle. For example, a person may drive the motor vehicle from the load zone to the beginning of a string of cargo sections. The beginning of the string of the cargo sections may include a ramp. A second person may drive the motor vehicle from the ramp and into the cargo section.

As one example of a moving session, the motor vehicles 130 that are designated as C2 in FIG. 2 are moved through the second levels of the cargo sections A and B and moved into the second level of the cargo section C. As such, the second level of the cargo section C is filled, but the second levels of the cargo sections A and B are empty and allowed to receive motor vehicles 130. During the same moving session (or a subsequent moving session), the motor vehicles 130 designated as B2 are moved through the second level of the cargo section A and into the second level of the cargo section B. As such, the second levels of the cargo sections C and B are filled, but the second level of the cargo section A is empty and allowed to receive motor vehicles. During the same moving session (or a subsequent moving session), the motor vehicles 130 designated as A2 are moved to the second level of the cargo section A. Accordingly, the second levels of the string of the cargo sections A, B, and C are filled during one or more moving sessions. The number of moving sessions may be a function of the number of drivers and the number of motor vehicles that fill the cargo sections. In the above example, the two motor vehicles C2 are a second cargo sub-set of the railcar C, the two motor vehicles B2 are a second cargo sub-set of the railcar B, and the two motor vehicles A2 are a second cargo sub-set of the railcar A. The two motor vehicles C1 are a first cargo sub-set of the railcar C, the two motor vehicles B1 are a first cargo sub-set of the railcar B, and the two motor vehicles A1 are a first cargo sub-set of the railcar A. The cargo set of the railcar C includes the motor vehicles C1 and C2, the cargo set of the railcar B includes the motor vehicles B1 and B2, and cargo set of the railcar A includes the motor vehicles A1 and A2.

In the illustrated embodiment, only two motor vehicles 130 are shown at each level of the cargo section 120. It should be understood that more than two motor vehicles 130 may be positioned at a single level of the cargo section. For instance, a single level of a cargo section 120 may hold three motor vehicles 130, four motor vehicles 130, or more. Alternatively, a cargo section may be capable of holding at most one motor vehicle.

In the above example, the motor vehicles C2, C2, B2, B2, and A2 (in order) move through the exit 136 of a load zone 118-1. The motor vehicles A2, C1, C1, B1, and B1 (in order) then move through the exit 136 of a load zone 118-2, and the motor vehicles A1, A1 then move through the exit 136 of a load zone 118-3. It should be noted that the motor vehicles having the same cargo section designation (e.g., A1, A1, A2, A2) are not necessarily the same type of car. Instead, the motor vehicles designated as A1, A1, A2, A2 may include one type of motor vehicle or two, three, or four different types of motor vehicles. This example illustrates that the motor vehicles 130 of a load set of a single load zone 118 may be loaded onto the same string of cargo sections 120. As such, at least one entire load zone 118 may be emptied by a ground team during one moving session. In this example, a column of the motor vehicles 130 are driven one after the other through the exit 136, toward the cargo zone 109, and through a series of cargo sections 120.

In other embodiments, however, the load set of a single load zone may be used to fill separate strings of cargo sections 120. For example, the load set of the load zone 118-4 in FIG. 2 includes the motor vehicles E2, H2, E2, H2, and D2 (in order). In this case, the cargo sections E and H are within two different strings of cargo sections, but are filled during the same moving session. The two different strings are adjacent strings so that movement by the workers may be reduced.

As another example of how the strings of cargo sections may be filled, a single moving session may include moving portions of the load sets from two adjacent load zones. For example, the motor vehicles J2 may be removed from two different load zones 118-5, 118-6 and loaded onto the second level of the cargo section J. The motor vehicles K2 may be removed from two different load zones 118-5, 118-6 and loaded onto the second level of the cargo section K. The motor vehicles L2 may be removed from two different load zones 118-5, 118-6 and loaded onto the second level of the cargo section L. As such, a single moving session may include removing motor vehicles 130 from the load sets of adjacent load zones 118-5, 118-6 and loading the motor vehicles 130 onto cargo sections 120 of different strings of cargo sections.

As shown in FIG. 3, as the load zones 118 are emptied by one ground team, another ground team may be moving new motor vehicles 130 (shown as dashed boxes) from the receiving zone 106 (FIG. 1) to the recently emptied load zones 118. The load zones 118 may be filled with load sets that are constructed as described above. For example, the load sets may be configured to reduce (a) an amount of time (e.g., estimated or predicted amount of time) to move the motor vehicle 130 from the load zone 118 to the cargo section 120; (b) a distance (e.g., estimated or predicted amount of distance) to move the motor vehicle 130 from the load zone 118 to the cargo section 120; (c) a number of times (e.g., estimated or predicted number of times) in which an individual handles the motor vehicle 130 or other motor vehicle 130 in attempting to move the motor vehicle 130 toward the assigned cargo section 120; or (d) blockages in the load zones 118 caused by stationary motor vehicles 130. As described herein, one or more blockages may be unavoidable during operation at the product-distribution site 100. In some embodiments, one or more fill load zones 118 may have a single type of motor vehicle 130 that replaces another motor vehicle 130 or is otherwise used to fill a railcar 120. Accordingly, one or more embodiments may utilize load zones 118 with load sets that substantially overlap with cargo sets or cargo sub-sets and fill load zones 118 that do not substantially overlap with cargo sets.

Also described herein, each of the load zones 118 may have a zone location, and each of the railcars 120 may have a section location. For example, the railcar A has a section location, and the load zone 118-1 has a zone location. Embodiments may be configured to determine loading parameters associated with different pairs of zone locations and section locations. For example, the section location of railcar A and the zone location of load zone 118-1 have associated loading parameters; the section location of railcar A and the zone location of load zone 118-2 have associated loading parameters; the section location of railcar A and the zone location of load zone 118-3 have associated loading parameters; the section location of railcar A and the zone location of load zone 118-4 have associated loading parameters; and so forth. Likewise, the section location of railcar B and the zone location of load zone 118-1 have associated loading parameters; the section location of railcar B and the zone location of load zone 118-2 have associated loading parameters; the section location of railcar B and the zone location of load zone 118-3 have associated loading parameters; the section location of railcar B and the zone location of load zone 118-4 have associated loading parameters; and so forth. Thus, a section location may have associated loading parameters with respect to the different zone locations, and a zone location may have associated loading parameters with respect to the different section locations.

Loading parameters are a function of one or more costs (e.g., time, money, risk to products, risk to workers, etc.) for moving a motor vehicle 130 from one zone location to a section location. Embodiments may be configured to reduce these costs. For example, the loading parameters may be based on at least one of: (a) an amount of time to move the motor vehicles from the zone locations to the section locations; (b) a distance to move the motor vehicles from the zone locations to the section locations; or (c) a number of times in which individuals handle the motor vehicles or other motor vehicles in attempting to move the motor vehicles to the section locations. In particular embodiments, the loading parameters may be based on a distance to move the motor vehicles from the zone locations to the section locations. Embodiments may be configured to reduce a total distance traveled by a ground team during a moving session. Alternatively or in addition to this, embodiments may be configured to reduce a total distance traveled by a ground team during a work shift. Alternatively or in addition to this, embodiments may be configured to reduce a total distance traveled by the multiple ground teams during the same work shift. Alternatively or in addition to this, embodiments may be configured to reduce a total distance traveled by the multiple ground teams during the same work day.

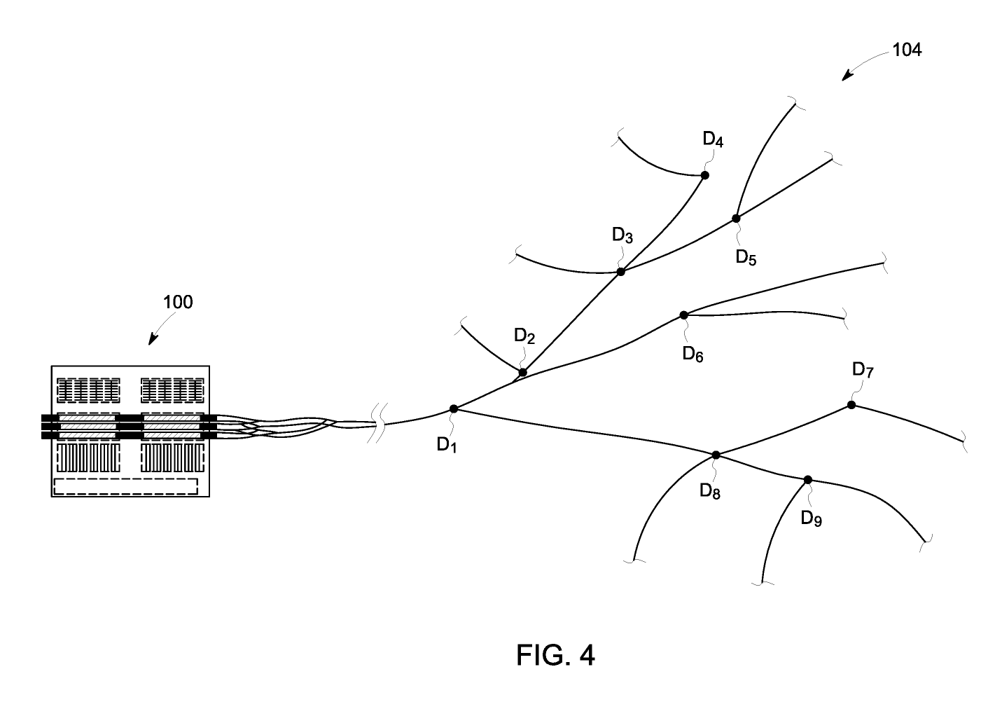

FIG. 4 illustrates the transportation network 104 in greater detail. The transportation network 104 includes the product-distribution site 100. For illustrative purposes, only a portion of the transportation network 104 is provided in FIG. 4. As shown, the transportation network 104 includes destinations D₁-D₉. The destinations D₁-D₉ may correspond to designated routes in which at least some of the routes overlap. For example, the route from the product-distribution site 100 to D₄ and the route from the product-distribution site 100 to D₅ overlap from the product-distribution site 100 to the destination D₃. The destinations D₁-D₉ may be at the intersections of various routes. For example, the destination D₃ interconnects four different tracks, and the destination D₁ interconnects three different tracks.

The destination D₃ includes a classification site 150. One or more of the other destinations D₁-D₂ and D₄-D₉ may include another product-distribution sites and/or a classification sites (not shown). The other product-distribution site may be similar or identical to the product-distribution site 100. A classification site is a site in which the railcars of the vehicle system may be divided and combined to effectively form new arrangements of the railcars (or to effectively form new vehicle systems). The classification sites may also be referred to as network hubs.

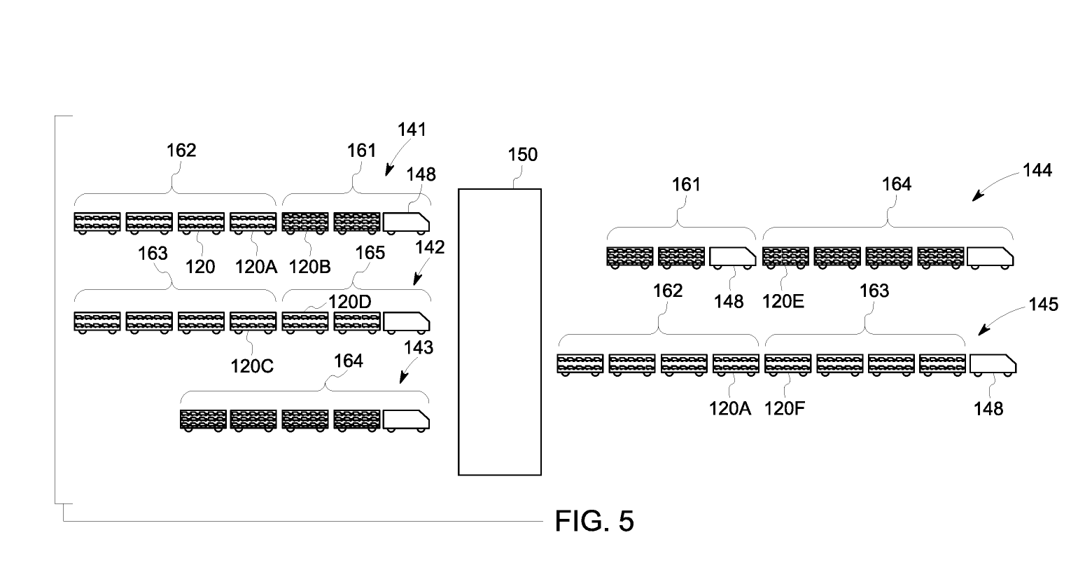

To illustrate what may occur at the classification site 150, FIG. 5 provides first, second, and third vehicle systems 141, 142, 143. Each of the vehicle systems 141-143 includes one or more railcars 120 and one or more propulsion-generating vehicles 148, such as a locomotive. The vehicle systems 141-143 may travel along the same or different routes to the classification site 150. The classification site 150 may be configured to sort the railcars 120 and the propulsion-generating vehicles 148 of the vehicle systems 141-143 to effectively form fourth and fifth vehicles systems 144, 145. The fourth and fifth vehicle systems 144, 145 are constructed, at least in part, from the railcars 120 and the propulsion-generating vehicles 148 of the vehicle systems 141-143. As used herein, a vehicle system is “different” or “effectively different” from another vehicle system if the two vehicle systems have either (a) a different number of vehicles or (b) a different arrangement of the same vehicles.

Embodiments set forth herein may be configured to reduce a number of sorting events, which may also be referred to as switching events. A sorting event occurs when adjacent railcars 120 are separated from one another and at least one of the railcars 120 is moved to a new position with respect to the other railcars of the vehicle system or moved to a new vehicle system. By way of example, the vehicle systems 141-143 include strings 161-164 of interconnected vehicles. The interconnected vehicles include railcars 120 and propulsion-generating vehicles 148. In the illustrated embodiment, each of the strings 161-164 is a string or series of vehicles in which the vehicles are connected end-to-end.

For other embodiments that handle other commercial products, it is contemplated that sets of commercial products may form a two-dimensional or three-dimensional stack. For example, intermodals may be positioned end-to-end and side-to-side in a two-dimensional stack. Additional two-dimensional stacks of the intermodals may be positioned on top of one another to form a three-dimensional stack. In such embodiments, a sorting event occurs when adjacent cargo sections of a set are separated from one another and at least one of the cargo sections is moved to a new position with respect to the other cargo sections of the set or the cargo section is moved to an entirely new set.

The number of sorting events may be reduced by interconnecting strings that include a greater number of vehicles. For example, the vehicle system 141 includes the strings 161 and 162. The vehicle system 142 includes the strings 163 and 165, and the vehicle system 143 includes the string 164. The string 164 is the entirety of the vehicle system 163, whereas the strings 161-163 and 165 are only portions of the vehicle systems. At the classification site 150, the strings 161-165 may be separated from one another and/or connected to other strings 161-165. For example, to construct the vehicle system 144, a first sorting event may be decoupling the strings 161 and 162. More specifically, the adjacent railcars 120A, 120B may be decoupled from each other. A second sorting event may be decoupling the string 163 from the string 165. In particular, the adjacent railcars 120C, 120D may be decoupled from each other. To construct the vehicle system 144, a fourth sorting event may be coupling the string 164 and the string 161. More specifically, the propulsion-generating vehicle 148 of the string 161 may be coupled to the railcar 120E of the string 165. To construct the vehicle system 145, a fifth sorting event may be coupling the string 162 and the string 163 and a sixth sorting event may be coupling the propulsion-generating vehicle 148 to a leading end of the vehicle system 145. In particular, the railcar 120A of the string 161 may be coupled to a railcar 120F of the string 163.

When the motor vehicles 130 are assigned to the railcars 120 at the product-distribution site 100, the motor vehicles 130 may be assigned in a manner to reduce the number of sorting events that occur at the product-distribution site 100 (e.g., for marrying the railcars 120 and assembling the vehicle system), reduce the number of sorting events that occur downstream in the network, reduce costs in unloading the motor vehicles 130 at the final destinations of the railcars 120. To provide one example, a first group of railcars 120 may have similar or identical routes and be grouped together in a first block of a vehicle system, and a second group of railcars 120 may have similar or identical routes and be grouped together in a second block of the same vehicle system. When the vehicle system arrives at a classification site, the first block may be used to form a first vehicle system and the second block may be used to form a different second vehicle system. At a subsequent classification site, the first block may be separated into several groups and these groups may be used to form other vehicle systems. When the motor vehicles 130 are assigned to the railcars 120 at the product-distribution site 100, the motor vehicles 130 may be assigned to reduce the number of sorting events at the subsequent sites. Alternatively or in addition to this, the motor vehicles 130 may be assigned to reduce the costs in unloading the motor vehicles 130 at the final destination of the railcars 120. In other words, the motor vehicles 130 may be assigned to simplify subsequent sorting of the railcars 120 and/or unloading of the motor vehicles 130.

The costs in unloading the motor vehicles 130 may be a function of unloading parameters, which may be similar to the loading parameters for loading the motor vehicles 130. For example, the unloading parameters may be based on at least one of: (a) an amount of time to unload the inbound motor vehicles 130 from the section locations to bay locations; (b) a distance to move the inbound motor vehicles 130 from the section locations to the bay locations; or (c) a number of times in which individuals handle the inbound motor vehicles 130 or other vehicles in attempting to unload the motor vehicles 130.

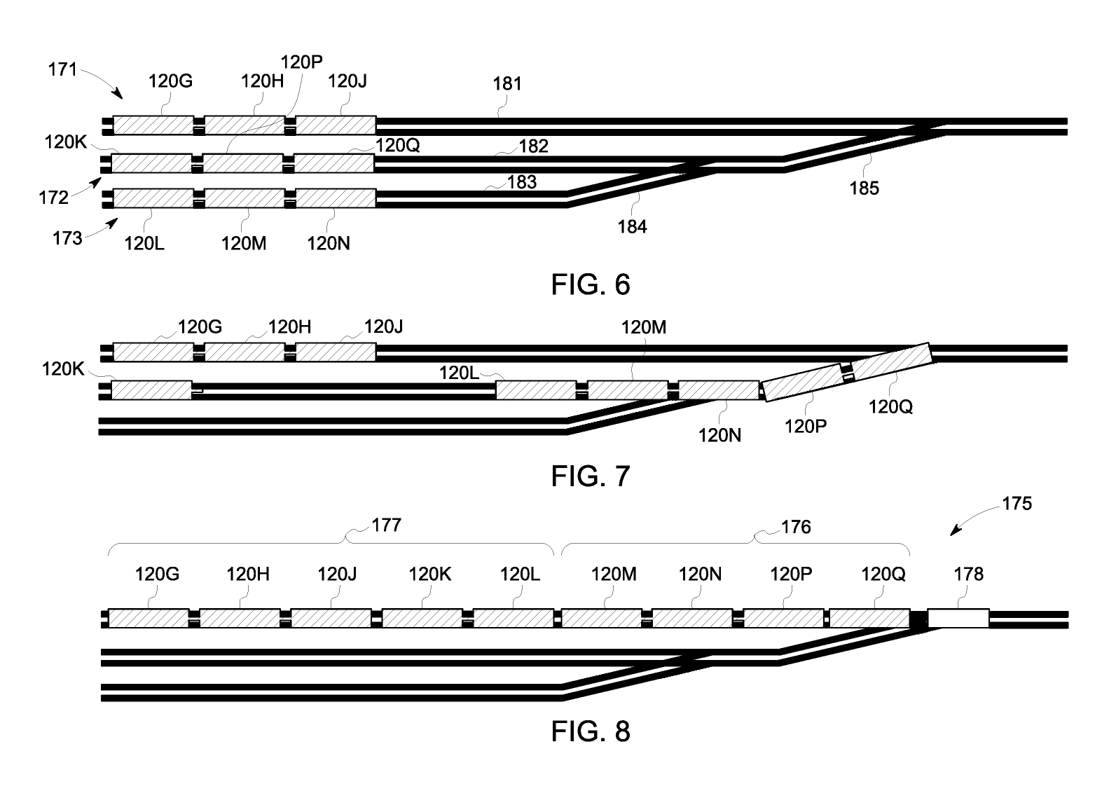

In addition to coupling and de-coupling vehicles, sorting events may include moving the cargo sections and/or the propulsion-generating vehicles to designated positions to permit the coupling and/or decoupling of the vehicles. To demonstrate such sorting events, FIGS. 6-8 illustrate how strings 171-173 (FIG. 6) may be combined to form a string 175 (FIG. 8) of cargo sections 120. As described herein, the string 175 is configured to have a designated makeup of the cargo sections 120. The designated makeup may be configured to reduce subsequent sorting events that must occur at other sites in the transportation network 104. For example, the string 175 includes a first block (or sub-set) 176 and a second block (or sub-set) 177. As block may be another name for a string of cargo sections. A block of cargo sections, however, typically includes a large number of cargo sections (e.g., at least four and often twenty, thirty, fifty, hundred, or more cargo sections). At a subsequent site, the blocks 176 and 177 may be separated from each other and used to form different vehicle systems. Different blocks of cargo sections typically represent cargo sections that will be separated from one another at some point during transportation. For example, the two vehicles that interconnect different blocks will be separated from each other at some point during transportation.

To illustrate one example, the string 175 (FIG. 7) includes, in order, cargo sections 120G, 120H, 120J, 120K, 120L, 120M, 120N, 120P, and 120Q. As shown in FIG. 6, the cargo sections 120G, 120H, 120J, 120K, 120L, 120M, 120N, 120P, and 120Q are originally part of the strings 171-173. Specifically, the cargo sections 120G, 120H, 120J (in order) are in the string 171. The cargo sections 120K, 120P, 120Q (in order) are in the string 172. The cargo sections 120L, 120M, 120N (in order) are in the string 173.

The strings 171-173 are positioned to move along tracks 181-183, respectively. The tracks also include tracks 184 and 185. The track 184 joins the tracks 183 and 182. The track 185 joins the tracks 182 and 181. To assemble or construct the string 175, the cargo sections of the strings 171-173 may be separated from one another, combined with other cargo sections, and/or moved along the tracks 181-185 in a plurality of sorting events. For example, a first sorting event may be to separate the cargo sections 120K and 120P. A second sorting event may be to move the sub-string (120P and 120Q) forward along the track 182 and onto the track 185. A third sorting event may be to move the string 173 along the track 183 and 184 toward the sub-string. A fourth sorting event may be to couple the cargo sections 120N and 120P to form a new string 174 (shown in FIG. 7). A fifth sorting event may be to move the cargo section 120K toward the new string 174. A sixth sorting event may be to couple the cargo section 120K to the cargo section 120L to form a larger string (not shown). A seventh sorting event may be to move the larger string onto the track 181. An eighth sorting event may be to move the larger string backward toward the string 171. A ninth sorting event may be to couple the cargo sections 120J and 120K to form the string 175 (FIG. 8). In this manner, the string 175 may be constructed in which the cargo sections 120 have a designated makeup. A propulsion-generating vehicle 178 (e.g., locomotive) may be coupled to a lead end of the string 175. In some embodiments, the propulsion-generating vehicle 178 is used to move one or more of the strings 171-173, 175.

As described above, the re-arranging of cargo sections at the product-distribution site 100 may take several sorting events. Similar sorting events (e.g., coupling events and moving events) may be taken to marry the cargo sections and/or re-sort the cargo sections at other sites. The designated makeup may be configured to reduce at least one of marrying the cargo sections 120 at the product-distribution site 100 or re-sorting the cargo sections 120 after the vehicle system has departed the product-distribution site 100.

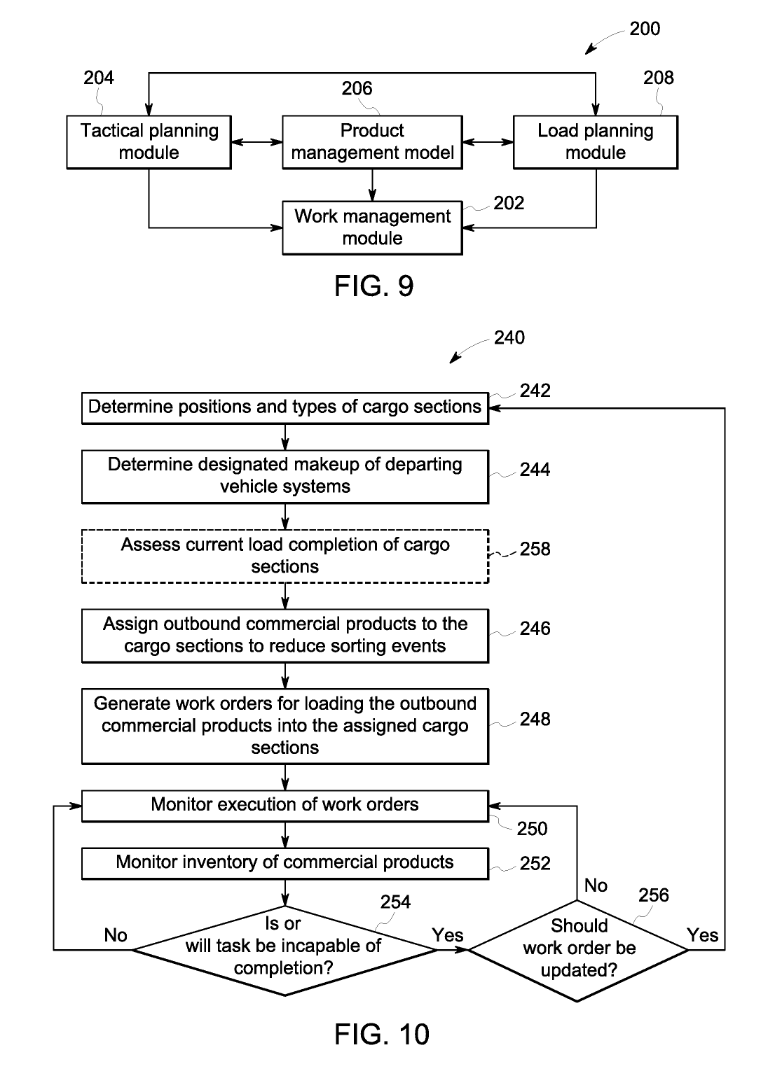

FIG. 9 illustrates a product-distribution system 200 in accordance with an embodiment. The product-distribution system 200 is configured to monitor operations (e.g., movement of commercial products, including loading or unloading) at the product-distribution site 100. The product-distribution system 200 may obtain data for performing these operations, analyze the data, and generate one or more tasks to be performed at the product-distribution site 100. The tasks may be provided in instructions or work orders and carried out by a team or crew of workers. The product-distribution system 200 includes at least one of a tactical planning module 204, a product management module 206, and a load planning module 208. The product-distribution system 200 may also include a work order management module 202. It should be understood that the various modules 202, 204, 206, 208 may communicate with one another. For example, the various modules 202, 204, 206, 208 may receive input data from the other modules. In some cases, the input data may be provided manually by a user. The various modules 202, 204, 206, 208 may also be configured to work independently from one another.

In some instances, the execution of one module may cause or trigger the execution of another module or modules. As used herein, an “execution” of a module may be a first run execution or a re-execution of the module. During an execution of the module, the module may generate a work order (e.g., a new work order or a revised work order) using updated information. For example, a work order generated by the tactical planning module 204 may trigger the generation of a work order from the product management module 206, which may trigger the generation of a work order from the load planning module 208. In some embodiments, the modules are capable of running independently (e.g., without prior execution of another module). In some embodiments, one or more modules may be executed less frequently than another module or modules. For example, the tactical planning module 204 may be executed less frequently than the product management module 206 and the load planning module 208.

The modules 202, 204, 206, 208 may include a computer processor, controller, or other logic-based device that performs operations based on instructions stored on a tangible and non-transitory computer readable storage medium, such as a computer memory, of the product-distribution system. Alternatively, the modules 202, 204, 206, 208 may include a hard-wired device that performs operations based on hard-wired logic and circuitry of the device. The modules shown in the attached figures may represent the hardware and circuitry that operates based on software or hardwired instructions, the software that directs hardware to perform the operations, or a combination thereof. The modules 202, 204, 206, 208 can include or represent hardware circuits or circuitry that include and/or are connected with one or more processors, such as one or computer microprocessors. It should be understood that one or more functions of one module may be carried out by another module in alternative embodiments. For example, one or more functions of the tactical planning module 204 may be carried by the load planning module 208 in other embodiments.

The tactical planning module 204 is configured to allocate physical space at the product-distribution site 100 for different activities. For example, the tactical planning module 204 may determine, as a function of time, how space at the product-distribution site should be allocated for activities. The activities may be carried out by individuals and/or machines (e.g., robotic systems). In particular embodiments, the activities may include remotely controlling a motor vehicle to move to a designated position. These activities may include moving, storing, loading, and/or unloading the commercial products. More specifically, the activities may include (1) receiving commercial products at a receiving zone and moving the commercial products from the receiving zone; (2) moving the commercial products to designated positions within load regions (or load zones); (3) moving the commercial products from the load regions and loading the commercial products into designated cargo sections or, more specifically, to designated positions within the cargo sections within cargo zones; or (4) unloading the commercial products from cargo sections and moving the commercial products to bay areas. Accordingly, the tactical planning module 204 may allocate, as a function of time, designated areas for one or more receiving zones, one or more load regions, one or more cargo zones, and one or more bay areas. When allocating a designated area, the tactical planning module 204 may determine a size of the area and a location of the area within the product-distribution site.

Optionally, the tactical planning module 204 may determine when cargo sections should be moved into the cargo zones. The tactical planning module 204 may also determine where the cargo sections should be positioned within the cargo zones. The tactical planning module 204 may perform these functions using, for example, a current inventory of commercial products and an expected (or predicted) inventory of commercial products that includes commercial products that will arrive at the product-distribution site 100. The tactical planning module 204 may generate work orders that are communicated to the work order management module 202. The work order management module 202 may monitor any tasks provided in the work order to determine if and when the tasks are completed.

The tactical planning module 204 may generate a plan that improves compliance with preferences for cargo sections in the transportation network. For example, various sites may be configured to use only certain types of cargo sections or may require certain types of cargo sections for operation. More specifically, one or more sites within a network may be capable of handling cargo sections that have certain physical attributes. Alternatively, one or more sites within a network may be requesting that certain types of cargo sections be moved to the product-distribution site. For example, a site may be running out of cargo sections of a certain type so the tactical planning module 204 may generate a plan that delivers the needed cargo sections to the product-distribution site. In other embodiments, the load planning module 208 may generate a plan that improves compliance with preferences for cargo sections in the transportation network as described above.

Non-limiting examples of physical attributes of a cargo section include size and shape of the cargo sections, number of levels, elevations of certain levels, or type of guiding system (e.g., rails), if any, within the cargo section. With specific reference to railcars, one type of railcar is a bi-level railcar having decks that are 86 inches (218 centimeters) apart (e.g., first and second levels are separated by 86 inches). Another type of railcar is a bi-level railcar having decks that are 87 inches (221 centimeters) apart. Some sites may be configured to load and/or unload 86-inch bi-level railcars whereas other sites may be configured to load and/or unload 87-inch bi-level railcars. By way of example, a remote site may have an insufficient number of one type of railcar. The tactical planning module 204 (or load planning module 208) may generate a plan that delivers this type of railcar to the remote site. When the railcar is delivered, the railcar may also have commercial products.

The plan may also be configured to improve or maximize compliance with delivery commitments. For example, a product-distribution site may have agreements to ship a designated number of commercial products for one or more customers/clients. A product-distribution site may also have agreements to limit dwell time of the commercial products (e.g., time at which a commercial product will remain at the product-distribution site). The tactical planning module 204 may develop an operating plan that attempts to achieve a delivery commitment and/or reduce dwell time of the commercial products.

The plan generated by the tactical planning module 204 may be based on various input data. The input data may be manually entered by a user, communicated to the product-distribution site 100 through a communication network, and/or automatically determined by the tactical planning module 204 or other modules. The input data may include, for example, a schedule of the vehicle systems. The schedule of the vehicle system may include an estimated time of arrival and/or an estimated time of departure. The input data may also include a blocking plan for the incoming and outgoing vehicle systems. A blocking plan specifies a makeup of the vehicle system. For example, the blocking plan may specify the position of a string of cargo sections within the vehicle system and/or relative to other strings or cargo sections. Each of the cargo sections for an outbound vehicle system may have a specified set of commercial products and a designated route for the cargo section to travel. A single outbound vehicle system may include cargo sections with different designated routes.

The input data used by the tactical planning module 204 may also include the estimated time of arrival of designated cargo sections in addition to the type of cargo section and commercial products loaded onto the cargo sections. The input data may also include a total number of empty cargo sections within the product-distribution site, including the positions and types of cargo section for the cargo sections. The input data may also include a representation (or map) of the topology of the product-distribution site (e.g., link node network). The map provides a way of measuring distances traveled by the commercial products and/or cargo sections within the product-distribution site. The input data may also include site preferences for the cargo sections. The product-distribution site preferences may be a function of location, volume, and time.

The input data may also include: (1) delivery commitments; (2) number of shifts per day and size of the teams for each shift; (3) a predicted number of commercial products that will be arriving through a first transportation network; (4) a predicted number of commercial products that will be arriving through a second transportation network; (5) a predicted number of commercial products that will be arriving through a third transportation network; (6) a predicted number of commercial products that will be departing through a first transportation network; (7) a predicted number of commercial products that will be departing through a second transportation network; (8) a predicted number of commercial products that will be departing through a third transportation network; (9) advanced shipment notifications (ASNs) for commercial products; (10) a current number of commercial products within the product-distribution site (e.g., current inventory); (11) locations of the commercial products within the product-distribution site; (12) configurations of the cargo sections within the cargo zones (e.g., railcar positions along each track in the rail pads); (13) loading templates for loading cargo sections; and (14) time and effort estimates for loading and unloading cargo sections and other site operations.

The tactical planning module 204 may generate work orders that include, for example, assignments of empty or inbound cargo sections to designated positions within the cargo zones. The tactical planning module 204 may designate certain regions of the product-distribution site as receiving zones, load regions, cargo zones, or bay zones as a function of time. These designations may be based on time such that one or more areas in the product-distribution site may serve as one type of region (e.g., load zones) for a first time period and a second type of region (e.g., bay area) for a second time period. The tactical planning module 204 may also generate work orders that assign cargo sections to designated positions within the cargo zones. For example, the tactical planning module 204 may analyze the makeups of the outgoing cargo sections and determine where the cargo sections should be positioned within the cargo zones. In some embodiments, the work orders that assign cargo sections to designated positions within the cargo zones may be generated by the load planning module 208.

In some embodiments, the tactical planning module 204 will be executed periodically, such as every designated number of minutes or hours (e.g., one hour, two hours, and so on) or every shift. In some embodiments, the tactical planning module 204 will be executed when there are significant changes to the input data. In some embodiments, the tactical planning module 204 will be executed when it is determined that a work order cannot be completed. For example, if a work order assigns commercial products to designated load zones, but the designated load zones are full or the commercial products are incapable of being moved to the assigned load zones (e.g., because a pathway is blocked), the tactical planning module 204 may be re-executed. During the re-execution, the tactical planning module 204 may use updated information that indicates that the designated load zones are full and/or that commercial products are incapable of being moved to the assigned load zones.

The product management module 206 is configured to assign inbound commercial products to different locations within the physical space. As an example, the product management module 206 may assign motor vehicles that are received at the receiving zone to designated positions within load regions. More generally, the product management module 206 may assign the commercial products to load regions (or load zones) as the commercial products arrive. The product management module 206 may assign the commercial products to specific load zones so that the load zones have specified sets therein. The specified sets may be based on the makeups of the vehicle systems that are scheduled to depart the product-distribution site 100. The product management module 206 may generate work orders that are communicated to the work order management system 202. The product management module 206 may generate a plan based on expected inventories of the commercial products. As an example, the product management module 206 may generate a plan that is based on expected VIN inventories by route. The product management module 206 may dynamically allocate the motor vehicles to designated load zones as the motor vehicles are identified within the receiving zone. In some embodiments, the specified sets of motor vehicles may be constructed to include (1) motor vehicles having the same or overlapping routes; (2) motor vehicles that will be assigned to the same deck level and/or the same railcar; and/or (3) motor vehicles of a common type.

As described in greater detail below, the product management module 206 may assign the outbound commercial products to load zones to reduce at least one of a total time or a total distance to move the outbound commercial products from zone locations to designated section locations or a total number of times in which individuals handle the products in moving the products toward the section locations.

Work orders generated by the product management module 206 may be based on various input data. The input data may be manually entered by a user, communicated to the product-distribution site 100 through a communication network, and/or automatically determined by the product management module 206 or other modules. Non-limiting examples of input data that may be used by the product management module 206 include: (1) locations of cargo sections within cargo zones; (2) a representation of the topology of the product-distribution site (e.g., link node network); (3) estimated time of arrivals for inbound commercial products; (4) sizes and locations (e.g., coordinates) of the different activity regions (e.g., receiving zone, load regions, cargo zones, bay area); (5) attributes of the commercial products; (6) ASNs for commercial products in inventory or forecasted to be in inventory; (7) loading templates for the cargo sections; (8) number of teams and team size (e.g., number of individuals) for moving the commercial products; (9) average speeds for moving commercial products; (10) average number of times a commercial product may be handled in moving from one location to another; (11) locations of commercial products that are currently positioned within load zones; (12) designated number of commercial products that may be positioned within the different load zones (e.g., capacity of a load zone); or (13) blocked load zones. The product management module 206 may generate a work order that is based on any combination of the above parameters or other parameters not listed. As described below, the product management module 206 may determine loading parameters associated with different locations within the product-distribution site based on one or more of the above examples of input data.

In particular embodiments, the product management module 206 may generate instructions for moving the outbound commercial products from a receiving zone to the load zones. The instructions may be provided in a work order. The work order may be a visual representation of the instructions. For example, the work order may be printed onto a paper or displayed on a screen of a computing device (e.g., desktop computer, embedded computer, tablet computer, and/or smartphone). In particular embodiments, the work order provides a sequence for moving designated commercial products to the load zones.

The specified sets of the load zones may be based on expected inventories of the commercial products. One or more of the expected commercial products, however, may not arrive within a designated time period. In such instances, the product management module 206 may dynamically assign the commercial products to load zones through a heuristic routine. For example, the product management module 206 may assign the commercial products as the commercial products are received at the receiving zone and/or as the commercial products are identified (e.g., scanned).

In some embodiments, the product management module 206 will be executed periodically, such as every designated number of minutes or hours (e.g., one hour, two hours, and so on) or every shift. In some embodiments, the product management module 206 will be executed when there are significant changes to the input data. In some embodiments, the product management module 206 will be executed when it is determined that a work order cannot be completed. For example, if a work order assigns commercial products to designated load zones, but the designated load zones are full or the commercial products are incapable of being moved to the assigned load zones (e.g., because a pathway is blocked), product management module 206 may be re-executed. As another example, the tactical planning module 204 (or other module) may request that the product management module 206 be re-executed.

The load planning module 208 is configured to manage the loading and/or unloading of vehicle systems. For example, the load planning module 208 may generate instructions for unloading commercial products from the vehicle systems and/or generate instructions for loading commercial products onto the vehicle systems. In some instances, both the loading and unloading is performed by the same team of workers. After the team of workers have loaded the commercial products, the workers may follow instructions generated by the load planning module 208 for unloading nearby cargo sections. In some embodiments, the load planning module 208 may determine how cargo sections should be sequenced to construct the vehicle systems with the designated makeups. The sequences may be configured to reduce a number of sorting events for at least one of marrying the cargo sections at the product-distribution site or re-sorting the cargo sections after the vehicle system has departed the product-distribution site. The load planning module 208 may generate work orders that are communicated to the work order management system 202.

The load planning module 208 may use various input data in determining how to load the cargo sections and/or how to sequence the cargo sections within the cargo zones. The input data may be manually entered by a user, communicated to the product-distribution site 100 through a communication network, and/or automatically determined by the load planning module 208 or other modules. Non-limiting examples of input data that may be used by the load planning module 208 include: (1) final destinations of the commercial products in the load zones and, optionally, intermediate destinations of the commercial products; (2) a blocking plan for an outgoing vehicle system (e.g., a blocking plan of a train); (3) locations of the cargo sections within the product-distribution site and, more specifically, within the cargo zones; (4) the types of cargo sections; (5) physical attributes of the commercial products, which may determine which cargo sections can receive the commercial products; (6) blocked pathways or blocked load zones; (7) positions of commercial products within the load zones; (8) a representation (or map) of a topology of the product-distribution site (e.g., a link node network); (9) route restrictions for the commercial products; (10) any priorities applied to the commercial products; (11) number of teams and team size (e.g., number of individuals) for moving the commercial products; (12) availability of the teams; (13) time estimate for loading or unloading the commercial products; (14) loading templates; or (15) network cargo section use preferences by site, volume, and time.

As described above, the load planning module 208 may generate work orders that are based on a loading template. A loading template may provide rules as to how a cargo section may be loaded. For example, railcars may have a known length and the motor vehicles may have a known length and other physical attributes (e.g., height or width). The load planning module 208 may generate work orders that satisfy the loading templates of the cargo sections. For each specified set of commercial products within a cargo section, the load planning module 208 may generate a work order that loads the commercial products into the cargo section in a designated order. The designated order may maximize the use of space within the cargo section. A work order may include a designated sequence for loading the commercial products into the cargo sections.

In some embodiments, the load planning module 208 will be executed periodically, such as every designated number of minutes or hours (e.g., one hour, two hours, and so on) or every shift. In some embodiments, the load planning module 208 will be executed when there are significant changes to the input data. In some embodiments, the load planning module 208 will be executed when it is determined that a work order cannot be completed. For example, if a work order assigns commercial products to designated cargo sections, but the designated cargo sections are full or the commercial products are incapable of being moved to the assigned cargo sections (e.g., because a pathway is blocked), the load planning module 208 may be re-executed. As another example, the tactical planning module 204 (or other module) may request that the load planning module 208 be re-executed.

The work order management module 202 may be configured to communicate with the tactical planning module 204, the product management module 206, and/or the load planning module 208. The work orders generated by the tactical planning module 204, the product management module 206, and/or the load planning module 208 may be communicated to the work order management module 202. The work order management module 202 may monitor the execution of work orders and provide time estimates for when the various tasks in the work orders will be completed. In some embodiments, the work order management system 202 may request a new work order or a modified work order. For example, the work order management system 202 may determine that it is impossible or undesirable to complete a work order. In this case, the work order management system 202 may request another work order that satisfies one or more constraints.

FIG. 10 is a flow chart illustrating a method 240 in accordance with an embodiment. The method 240, for example, may employ structures or aspects of various embodiments (e.g., systems and/or methods) discussed herein. For example, the method 240 may be executed or performed by the product-distribution system 200 (FIG. 9). In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion.

The method 240 will be described with reference to the previously-described figures. The method 240 may include determining, at 242, positions and types of cargo sections. For example, the product-distribution site may have a number of cargo sections positioned within the cargo zones. Each cargo section may be one type of cargo section having predetermined physical attributes. Each cargo section may have a designated position within a cargo zone.

For example, the product-distribution site may have railcars that are positioned on tracks within the cargo zones. The railcars may be grouped together in strings. In FIG. 1, for example, each string of railcars 120 includes three railcars 120 coupled end-to-end on a track. The site includes three tracks 121-123 and each track has two strings of the railcars 120 for a total of eighteen (18) railcars 120 in FIG. 1. The railcars 120 in each string may be operably joined such that motor vehicles 130 may be driven from one railcar 120 to the adjacent railcar 120. As described above, different types of railcars may have different physical attributes for transporting motor vehicles such that at least one type of railcar is improper for carrying one or more motor vehicles. The positions of the different railcars within the cargo zones may be determined through a map of the site. In some embodiments, a position of a railcar is a location of the railcar within the site. In some embodiments, a position of the railcar is a position relative to other railcars. For example, a railcar may be in the first position (or end position), with the next railcar in the second position, with the next railcar in the third position, and so forth.

At 244, a designated makeup of one or more departing vehicle systems is determined. A designated makeup includes the cargo sections and the commercial products held by the cargo sections. The designate makeup may also include an order or arrangement of the cargo sections within the vehicle system. For example, a train may include a first (or lead) railcar, a second railcar, a third railcar, and so forth. A train may also include blocks or strings of railcars. Each string or block may remain coupled to each other after a sorting event. For example, a train may have first block having twenty railcars, a second block having thirty railcars, and a third block having twenty-five railcars. Each block may include sub-blocks or strings of railcars.

The commercial products within a cargo section may form a specified set. The commercial products of a specified set may have a predetermined order within the cargo section. Alternatively, the commercial products of a specified set may not have a predetermined order. The designated makeup may also include routes for the cargo sections and positions relative to one another in the vehicle system. For example, a blocking plan of a train may have routes assigned to the railcars.

At 246, the outbound commercial products may be assigned to the cargo sections. The outbound commercial products may be assigned to cargo sections to reduce a number of sorting events for at least one of marrying the cargo sections at the product-distribution site or re-sorting the cargo sections after the vehicle system has departed the product-distribution site. As described above, a sorting event may include a coupling event in which two railcars (or strings of railcars) are coupled to one another, a decoupling event in which two railcars (or strings of railcars) are separated from one another, or a moving event in which a railcar or string of railcars are moved along a track. As the number of sorting events increase, the overall time and cost for assembling a train may increase. Embodiments may assign commercial products to cargo sections so that a number of sorting events is reduced.

At 248, one or more work orders may be generated. As used herein, a work order may include one or more tasks to be completed. For example, the tasks may include moving the commercial products from one load zone to a designated cargo section. The tasks in a work order may be prioritized in a list. For example, a work order may list several tasks (e.g., five, ten, twenty or more) tasks to be completed. As described herein, embodiments may update or modify a work order by adding, removing, or changing tasks in the work order. In particular embodiments, the tasks that are added, removed, or changed are not tasks that are currently being completed. For example, the tasks that are added, removed, or changed may occur away from a top of the list so that the work flow is not disrupted. By way of example, a work order may include a list of ten tasks. When the work order is modified, task 6 may be replaced with a new task and tasks 9 and 10 may be changed. Thus, the work order may be changed without disrupting the flow of work.

Execution of the work orders may be monitored, at 250, as the various tasks in the work orders are performed. In addition, an inventory of the commercial products (both actual and predicted) may be monitored, at 252. For example, the site receives commercial products and ASNs as the tasks in the work orders are performed. At 254, embodiments may query whether a task is incapable of being completed. For example, a motor vehicle may have a dead battery or be out of gas. Because the motor vehicle is incapable of being moved, other motor vehicles in the load line may also be incapable of being moved. Thus, if the task was to move the motor vehicles of the load line to a railcar, the task is incapable of being completed. As another example, a pathway to or from the load line may be blocked. If the tasks are capable of being completed, the method 240 may return to monitoring, at 250, and monitoring, at 252.

At 256, embodiments may query whether a work order should be updated (or, in other words, whether a new work order should be generated). Various reasons exist for updating a work order. For example, if a task is incapable of being completed, a new work order may be generated using input data that indicates that task is incapable of being completed. Other reasons for updating a work order may include (1) a designated amount of time (e.g., five minutes, ten minutes, thirty minutes, one hour, two hours, and so forth) has elapsed since the work order was generated; (2) a user has requested that a new work order be generated; (3) or the makeup of a departing vehicle system has changed. When the new work order is generated, the method 240 may include assessing, at 258, a current load completion or status of the cargo sections. For example, one or more cargo sections may be partially or fully filled.

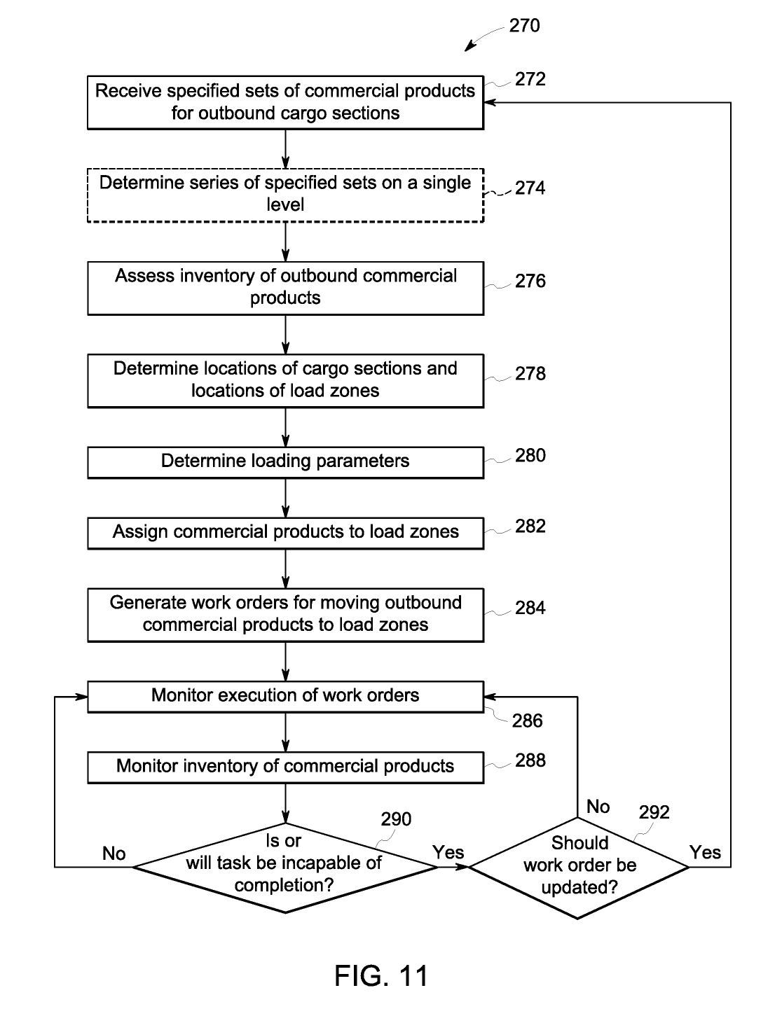

FIG. 11 is a flow chart illustrating a method 270 in accordance with an embodiment. The method 270, for example, may employ structures or aspects of various embodiments (e.g., systems and/or methods) discussed herein. For example, the method 270 may be executed or performed by the product-distribution system 200 (FIG. 9). In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion.

The method 270 will be described with reference to the previously-described figures. The method 270 may include receiving (or determining), at 272, specified sets of the commercial products for the outbound cargo sections. As described herein, the commercial products in a cargo section may constitute a specified set. Optionally, the method 270 may include determining, at 274, the commercial products that are on a designated level in operably joined cargo sections. For example, three bi-level railcars A, B, C may be operably joined such that a motor vehicle must be driven through railcar A and railcar B before loading the motor vehicle into the rail C. As such, the motor vehicles on the same level in railcars A, B, and C constitute a single series of motor vehicles. To reduce loading costs, the motor vehicles in this series may be arranged in series in a single load zone or in adjacent load zones.

At 276, an inventory of the outbound commercial products may be assessed. This assessment includes determining the commercial products that are currently on site (e.g., within the load zones or other areas of the site) and also predicting which commercial products will be received at the site within a designated period of time. The prediction may be based on ASNs received at the site.

The method 270 may include, at 278, determining section locations (e.g., locations of the cargo sections with the site) and determining zone locations (e.g., locations of the load zones within the site). Determining, at 278, may be performed by, for example, receiving or identifying coordinates or addresses of the cargo sections at the product-distribution site and receiving or identifying coordinates or addresses of the load zones at the product-distribution site. Determining, at 278, may also be performed using a database (e.g., lookup table) having the coordinates or addresses stored therein.

At 280, the loading parameters associated with the section locations and the zone locations may be determined. For example, each potential pair of zone locations and section locations may have loading parameters associated therewith. For example, moving a motor vehicle from load zone 1 to cargo section A may be estimated or predicted to require (a) three minutes of drive time; (b) a total of 300 meters traveled; and (c) only a single individual to move the motor vehicle. However, moving a motor vehicle from load zone 2 to cargo section G may be estimated or predicted to require (a) five minutes of drive time; (b) a total of 800 meters traveled; and (c) two individuals to move the motor vehicle. Each zone location may have loading parameters associated with each section location, and/or each section location may have loading parameters associated with each zone location.

In some embodiments, the commercial products in a common load zone have the same zone location and/or the commercial products in the same cargo section have the same section location. In other embodiments, however, each commercial product may have its own zone location and/or each commercial product may have its own section location. For example, assume a first commercial product, a second commercial product, and a third commercial product are in the same load zone. The first commercial product may have the first position in the load zone (e.g., first to be removed), the second commercial product may have the second position in the load zone (e.g., second to be removed), and the third commercial product may have the third position in the load zone (e.g., second to be removed). When determining the loading parameters, the loading parameters may be associated with each position in the load zone. For example, it may be a longer distance to move the third commercial product than the first commercial product and/or it may take a greater amount of time to move the third commercial product compared to the first commercial product.

The method 270 may assign, at 282, the outbound commercial products to the load zones. The outbound commercial products may be assigned to the load zones to reduce at least one of a total time or a total distance to move the outbound commercial products from the zone locations to the section locations or a total number of times in which individuals handle the products in moving the products toward the section locations. In some embodiments, the product-distribution system 200 may analyze various potential loading plans in which each loading plan includes a combination of moving events. The product-distribution system 200 identify one or more loading plans that reduce a total cost function.

For example, embodiments may simulate a plurality of potential loading plans (e.g., at least 10, at least 100, at least 500, at least 1000 loading plans, or more) in which each loading plan has a different combination of moving sessions and/or a different sequence of moving sessions. Each moving session may include moving a plurality of commercial products from potential load zones to potential cargo sections. Through these simulations, embodiments may identify a loading plan that reduces at least one of a total time or a total distance to move the commercial products from the zone locations to the section locations or a total number of times in which individuals handle the products in moving the products toward the section locations. In certain embodiments, embodiments may identify a loading plan that reduces at least one of a total time or a total distance to move the commercial products from the zone locations to the section locations. In particular embodiments, embodiments may identify a loading plan that reduces at least one of a total time to move the commercial products from the zone locations to the section locations. In particular embodiments, embodiments may identify a loading plan that reduces at least one of a total distance to move the commercial products from the zone locations to the section locations.

It should be understood that embodiments are not required to select the loading plan that requires the least total distance traveled, the least total time accumulated, and/or the least number of handling events occurring. For instance, embodiments may select the loading plan that has a total distance within the bottom half (less than 50%) of possible total distances, has a total time within the bottom half (less than 50%) of possible total times, or has a total number of handling events within the bottom half (less than 50%) of possible total handling events. Certain embodiments may select a loading plan that has a total distance that is at least within the bottom quartile (less than 25%) of possible total distances, has a total time that is at least within the bottom quartile (less than 25%) of possible total times, or has a total number of handling events that is at least within the bottom quartile (less than 25%) of possible total handling events. Particular embodiments may select a loading plan that has a total distance that is at least within the bottom 10% of possible total distances, has a total time that is at least within the bottom 10% of possible total times, or has a total number of handling events that is at least within the bottom 10% of possible total handling events.

At 284, one or more work orders may be generated. As used herein, a work order may include one or more tasks to be completed. For example, the tasks may include moving the commercial products from one load zone to a designated cargo section. The tasks in a work order may be prioritized in a list. The work orders may specify the sequence and/or timing of completing the tasks. At 286, execution of the work orders may be monitored as the various tasks in the work orders are performed. In addition, an inventory of the commercial products (both actual and predicted) may be monitored, at 288. For example, the site receives commercial products and ASNs as the tasks in the work orders are performed. At 290, embodiments may query whether a task is incapable of being completed. For example, a motor vehicle may have a dead battery or be out of gas. Because the motor vehicle is incapable of being moved, other motor vehicles in the load line may also be incapable of being moved. Thus, if the task was to move the motor vehicles of the load line to a railcar, the task is incapable of being completed. As another example, a pathway to or from the load line may be blocked. If the tasks are capable of being completed, the method 270 may return to monitoring, at 286, and monitoring, at 288.

At 292, embodiments may query whether a work order should be updated (or, in other words, whether a new work order should be generated). Various reasons exist for updating a work order. For example, if a task is incapable of being completed, a new work order may be generated using input data that indicates that task is incapable of being completed. Other reasons for updating a work order may include (1) a designated amount of time (e.g., five minutes, ten minutes, thirty minutes, one hour, two hours, and so forth) has elapsed since the work order was generated; (2) a user has requested that a new work order be generated; (3) or the makeup of a departing vehicle system has changed.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

As used herein, the terms “module,” “system,” “device,” or “unit,” may include a hardware and/or software system and circuitry that operate to perform one or more functions. For example, a module, unit, device, or system may include a computer processor, controller, or other logic-based device that performs operations based on instructions stored on a tangible and non-transitory computer readable storage medium, such as a computer memory. Alternatively, a module, unit, device, or system may include a hard-wired device that performs operations based on hard-wired logic and circuitry of the device. The modules, units, or systems shown in the attached figures may represent the hardware and circuitry that operates based on software or hardwired instructions, the software that directs hardware to perform the operations, or a combination thereof. The modules, systems, devices, or units can include or represent hardware circuits or circuitry that include and/or are connected with one or more processors, such as one or computer microprocessors.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims. The various embodiments are not limited to the arrangements and instrumentality shown in the drawings.

Since certain changes may be made in the above-described systems and methods without departing from the spirit and scope of the inventive subject matter herein involved, it is intended that all of the subject matter of the above description or shown in the accompanying drawings shall be interpreted merely as examples illustrating the inventive concept herein and shall not be construed as limiting the inventive subject matter.

What is claimed is:

1. A system comprising:
a product-distribution system configured to assign outbound automobiles to load zones for loading onto cargo sections of one or more vehicle systems, the cargo sections to be loaded with designated cargo sets of the outbound automobiles, the product-distribution system including one or more processors that are configured to:
determine loading parameters associated with section locations and zone locations, wherein the section locations are locations of the cargo sections at a product-distribution site and the zone locations are locations of the load zones at the product-distribution site, the loading parameters being based on at least one of: (a) an amount of time to move the outbound automobiles from the zone locations to the section locations; (b) a distance to move the outbound automobiles from the zone locations to the section locations; or (c) a number of times in which individuals handle the outbound automobiles in attempting to move the outbound automobiles to the section locations;
assign the outbound automobiles to the load zones, the load zones configured to have multiple outbound automobiles therein, wherein the outbound automobiles are assigned to the load zones to reduce at least one of a total time or a total distance to move the outbound automobiles from the zone locations to the section locations or a total number of times in which individuals handle the outbound automobiles in attempting to move the outbound automobiles to the section locations; and
generate a work order for moving the outbound automobiles from a receiving zone to the assigned load zones.

2. The system of claim 1, wherein the one or more processors are configured to assign the outbound automobiles to the load zones to provide designated load sets of the outbound automobiles within the load zones, the designated load sets being based on the designated cargo sets of the outbound automobiles within the cargo sections.

3. The system of claim 2, wherein the cargo sets and the load sets are specified lines and designated lines, respectively, in which the outbound automobiles of the specified and designated lines are aligned end-to-end in series, the designated lines and the specified lines at least partially overlapping.

4. The system of claim 1, wherein at least some of the outbound automobiles are assigned to the load zones as the outbound automobiles are received at the receiving zone.

5. The system of claim 1, wherein the cargo sections include present cargo sections in which the section locations are known to be at the product-distribution site and forecasted cargo sections in which the section locations are expected to arrive at the product-distribution site.

6. The system of claim 1, wherein the cargo sections are sized and shaped to have a designated number of the outbound automobiles and the load zones are sized and shaped to have a designated number of the outbound automobiles, wherein the designated number of the outbound automobiles of the load zones does not equal, for at least some cargo sections, the designated number of the outbound automobiles of the cargo sections.

7. The system of claim 1, wherein the load zones are load lines in which the outbound automobiles are configured to be arranged end-to-end in series, wherein the work order includes instructions for concurrently or sequentially moving all of the outbound automobiles in at least one of the load lines.

8. The system of claim 1, wherein the outbound automobiles are vehicles configured to be directed by individuals from the load zones to the cargo sections.

9. The system of claim 1, wherein the cargo sections include railcars and wherein the railcars include multi-level railcars having decks with different elevations, the decks of the multi-level railcars configured to receive sub-sets of the cargo sets of the outbound automobiles.

10. A method comprising:
determining loading parameters associated with section locations and zone locations, wherein the section locations are locations of cargo sections at a product-distribution site and the zone locations are locations of load zones at the product-distribution site, the loading parameters being based on at least one of: (a) an amount of time to move outbound automobiles from the zone locations to the section locations; (b) a distance to move the outbound automobiles from the zone locations to the section locations; or (c) a number of times in which individuals handle the outbound automobiles in attempting to move the outbound automobiles to the section locations;
assigning the outbound automobiles to the load zones, the load zones configured to have multiple outbound automobiles therein, wherein the outbound automobiles are assigned to the load zones to reduce at least one of a total time or a total distance to move the outbound automobiles from the zone locations to the section locations or a total number of times in which individuals handle the outbound automobiles in attempting to move the outbound automobiles to the section locations; and
generating a work order for moving the outbound automobiles from a receiving zone to the assigned load zones.

11. The method of claim 10, wherein the outbound automobiles are assigned to the load zones to provide load sets of the outbound automobiles within the load zones, the load sets being based on the cargo sets of the outbound automobiles within the cargo sections.

12. The method of claim 10, wherein at least some of the outbound automobiles are assigned to the load zones as the outbound automobiles are received at the receiving zone.

13. The method of claim 10, wherein the cargo sections include present cargo sections in which the section locations are known to be at the product-distribution site and forecasted cargo sections in which the section locations are expected to arrive at the product-distribution site.

14. The method of claim 10, wherein the load zones are load lines in which the outbound automobiles are configured to be arranged end-to-end in series, wherein the work order includes instructions for concurrently or sequentially moving all of the outbound automobiles in at least one of the load lines.

15. The method of claim 10, wherein the cargo sections include railcars and wherein the railcars include multi-level railcars having decks with different elevations, the decks of the multi-level railcars configured to receive sub-sets of the cargo sets of the outbound automobiles.

16. A system comprising:
a product-distribution system configured to generate a work order to a ground team at a product-distribution site for loading outbound automobiles onto cargo sections for transporting on one or more vehicle systems, the product-distribution system including one or more processors that are configured to:
determine locations of cargo sections in a cargo zone of the product-distribution site;
determine a designated makeup of an outbound vehicle system, the designated makeup specifying positions of the cargo sections within the vehicle system and specifying routes of the cargo sections, the cargo sections of the vehicle system being assigned different routes;
assign the outbound automobiles to the cargo sections, the outbound automobiles being assigned to cargo sections to reduce a number of sorting events for at least one of marrying the cargo sections at the product-distribution site or re-sorting the cargo sections after the vehicle system has departed the product-distribution site; and
generate the work order for loading the outbound automobiles.

17. The system of claim 16, wherein the cargo sections include different types of cargo sections, the different types of cargo sections having different physical attributes for transporting the outbound automobiles such that at least one type of cargo section is improper for carrying one or more of the outbound automobiles.

18. The system of claim 16, wherein at least some of the cargo sections include inbound automobiles, the work order generated by the one or more processors including instructions to move the inbound automobiles from the corresponding cargo sections to designated bay zones for transporting away from the product-distribution site.

19. The system of claim 16, wherein at least some of the cargo sections are operably joined to other cargo sections such that products may be moved through the operably joined cargo sections, the work order including instructions to move the outbound automobiles through a first cargo section and into a second cargo section.

20. The system of claim 16, wherein the one or more processors are configured to monitor completion of tasks in the work order, the one or more processors are configured to generate a new work order when a task is identified as being incapable of completion.
